(19) United States
(12) Patent Application Publication
(10) Pub. No.: US 2012/0304051 A1
(43) Pub. Date: Nov. 29, 2012

(54) Automation Tool for XML Based Pagination Process

(75) Inventors: Mahesh Balakrishnan, Chennai (IN); Madhu Rajamani, Chennai (IN)

(73) Assignee: DIACRITECH TECHNOLOGIES PVT LTD, Chennai (IN)

(21) Appl. No.: 13/245,352

(22) Filed: Sep. 26, 2011

(30) Foreign Application Priority Data
May 27, 2011 (IN) 1808/CHE/2011

(51) Int. Cl. G06F 17/00

(52) U.S. Cl. 715/239; 715/234

(57) ABSTRACT

A method and system for permitting automated pagination process in E-Publishing process, mainly on XML documents. The system facilitates XPATH based control for applying paragraph and character styles. Further, the system allows automatic layout of changes based on style specifications. Auto master page recognition feature of the system assures consistency in the page design. The system also facilitates auto placement of figures and tables according to a cited reference. The system is capable of auto generation and placement of boxes, side notes, footnotes and marginal notes in the document. Further, the system allows conversion of source XML to other formats such as NIMAS XML, EPub, and Word etc. Further, the file conversion has two stages namely Forward and Reverse process. During forward process, XML file is converted into InDesign document and in Reverse process, InDesign document is converted back to XML file.

### TECHNICAL FIELD

The embodiments herein relate to the field of document processing, presentation and conversion of documents from one format to another and, more particularly, to an automated XML based pagination process.

### BACKGROUND

E publishing allows copy-editing, graphics, pagination, technical editing and conversion to printable electronic format after receiving a raw text from a user. Pagination is the process of dividing running text into pages, including placement of footnotes, illustrations, and tables. Commonly used publishing systems serve as an effective tool for layout artists and page designers to do pagination. Publishing systems have their own set of Extensible Markup Language (XML) features. XML (Extensible Markup Language) is a set of rules for encoding documents electronically. In XML the tags or labels for various kinds of contents (document type declarations or DTD's) can be created based on the requirement for the content as decided by the publisher. The XML tools in Adobe InDesign which is a publishing system lets the user create InDesign templates into which data can be flowed from XML files and into the proper frames.

The Adobe InDesign publishing system suffers from many drawbacks with respect to pagination process. Processes involving construction of entity replacement text, conversion of MathML (Mathematical Markup Language—XML standard for encoding Mathematics), searching for elements (traversing XML document by stepping through each node) are tedious and time consuming tasks that cannot be automated with Adobe InDesign. Another problem is the process of applying footnotes in InDesign removed the associated tags of XML. In some situations after the InDesign document has been created, paginators may intentionally or inadvertently untag XML elements in the document, leading to compromises being made on the quality of the document. The placement of figures, library boxes, and tables, hiding unwanted content, applying styles, inserting side notes and marginal notes, applying multiple layers needs to be done manually. Exporting the Adobe InDesign document to Word or other formats causes special symbols and math related special characters to be changed.

There is currently no way of overcoming these drawbacks simultaneously, the user needs to work on each of the above manually to improve the document quality. This requires attention and time from users. Hence there is a need for an automated pagination tool, which lets the user control the pagination process while overcoming the drawbacks of the pagination processes.

### BRIEF DESCRIPTION OF THE FIGURES

The embodiments herein will be better understood from the following detailed description with reference to the drawings, in which:

FIG. 1 illustrates a broad block diagram that showing the overall auto pagination process, according to embodiments as disclosed herein;

FIG. 2 illustrates a list of various pagination processes selected by a user, as disclosed in the embodiments herein;

FIG. 3 illustrates a flow diagram which shows the process flow in DBInXML as disclosed in the embodiments herein;

FIGS. 4a-4f are flow diagrams which show a work flow in paginating and converting an XML input file to an InDesign output file as disclosed in the embodiments herein;

FIGS. 5a-5b are flow diagrams which show the process of converting InDesign to XML as disclosed in the embodiments herein;

FIG. 6 is a flow diagram which shows the process of converting InDesign to NIMAS XML as disclosed in the embodiments herein;

FIG. 7 is a flow diagram which shows the process of converting InDesign to ePUB as disclosed in the embodiments herein;

FIGS. 8a-8b are flow diagrams which show the process of converting InDesign to Word as disclosed in the embodiments herein;

FIGS. 9a-9b are flow diagrams which show the process of InDesign Format Attribute Conversion (IFA) as disclosed in the embodiments herein;

FIG. 10 is a flow diagram which shows the process of placing XML element in Adobe InDesign Document (PXE) as disclosed in the embodiments herein;

FIG. 11 is a flow diagram which shows the process of insertion of paragraph mark (IPM) in the document as disclosed in the embodiments herein;

FIG. 12 is a flow diagram which shows the process of Hiding Unwanted XML contents in the document as disclosed in the embodiments herein;

FIG. 13 is a flow diagram which shows the process of extending pages in document as disclosed in the embodiments herein;

FIGS. 14a-14d are flow diagrams which show the process of Applying Styles (AS) as disclosed in the embodiments herein;

FIG. 15 is a flow diagram which shows the process of Applying Table Styles (ATS) as disclosed in the embodiments herein;

FIGS. 16a-16c are flow diagrams which show the Equation Conversion Process (ECP) as disclosed in the embodiments herein;

FIG. 17a-17b are flow diagrams which show the process of Preceding Sibling Checking (PSC) as disclosed in the embodiments herein;

FIGS. 18a-18b are flow diagrams which show the process of Inside Placement (IP) as disclosed in the embodiments herein;

FIGS. 19a-19b are flow diagrams which show the process of Outside Placement (OP) as disclosed in the embodiments herein;

FIGS. 20a-20b are flow diagrams which show the process of inserting Foot Notes (FNE) as disclosed in the embodiments herein;

FIGS. 21a-21b are flow diagrams which show the process of Applying Master Page (AMP) as disclosed in the embodiments herein;

FIG. 22 is a flow diagram which shows the process of placing element contents in Different Layers (DLE) as disclosed in the embodiments herein;

FIG. 23 is a flow diagram which shows the process of moving overflowed text to slug area (SLG) as disclosed in the embodiments herein;

FIG. 24 is a flow diagram which shows the process of Attribute Deletion (ADL) as disclosed in the embodiments herein;

FIGS. 25a-25b are flow diagrams which show the process of Insertion of XML elements or contents or variable as disclosed in the embodiments herein;

FIG. 26 is a flow diagram which shows the forward process (FP) in Entity Mapping (EMP) as disclosed in the embodiments herein;

FIG. 27 is a flow diagram which shows the reverse process (RP) in Entity Mapping (EMP) as disclosed in the embodiments herein;

FIG. 28 is a flow diagram which shows the forward process (FP) sub tools for Pre and Post process (STP) as disclosed in the embodiments herein;

FIG. 29 is a flow diagram which shows the reverse process (RP) sub tools for Pre and Post process (STP) as disclosed in the embodiments herein;

FIG. 30 is a flow diagram which shows the process of Exporting XML Version (EXV) as disclosed in the embodiments herein;

FIGS. 31a-31b are flow diagrams which show the process of displaying attribute value in document for cross reference as disclosed in the embodiments herein;

FIG. 32 is a flow diagram which shows the process of InDesign table Formatting (ITF) as disclosed in the embodiments herein; and

FIG. 33 is a flow diagram which shows the process of Retagging in InDesign document as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

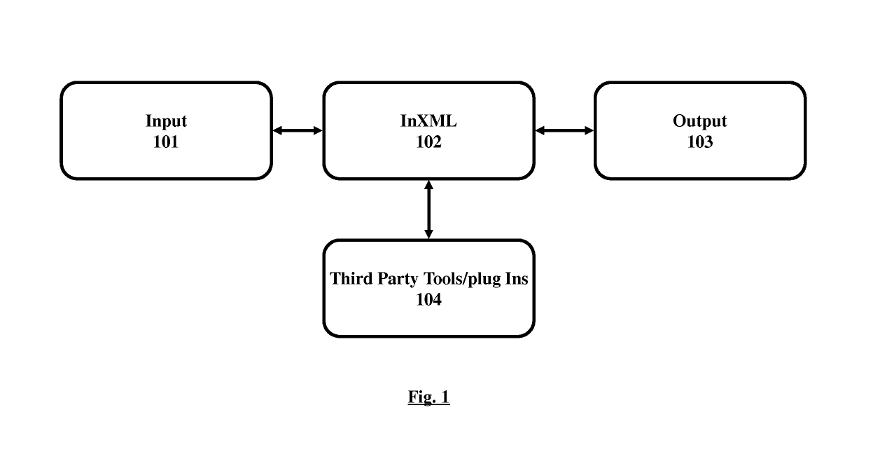

The embodiments herein disclose a method of automating pagination process in InDesign document by introducing an InXML tool. Referring now to the drawings, and more particularly to FIGS. 1 through 33, where similar reference characters denote corresponding features consistently throughout the figures, there are shown embodiments.

FIG. 1 illustrates a broad block diagram that showing the overall auto pagination process, according to embodiments as disclosed herein. The system comprises Input section 101, InXML 102, Output 103 and Third Party Applications 104. The input section 101 comprises of the input document, multiple Input Content creators such as DTD, XML, a database created by an DBInXML tool, Images, InDesign Template and Libraries and so on which act as sources of contents for InXML tool. In an embodiment, the database present in the input section is a collection of multiple Input Content such as DTD, XML, Database, Images, InDesign Template and Libraries and so on. In another embodiment, the bidirectional arrows refer to output of forward and reverse processes occurring in the system. Further, the output 103 may be any of InDesign documents, XML, NIMAS XML, MS Word and/or ePub based upon user requirement and service selection by the user. Further, the third party tools/Plug Ins refer to set of software components used for enhancing capabilities of the InXML tool application. The InXML tool makes use of all the input content received to perform required pagination and generate output 103 documents. The database produced by the DBInXML tool contains maps selected pagination processes to an XPath. Also the DBInXML tool analyzes the XML path in the input file.

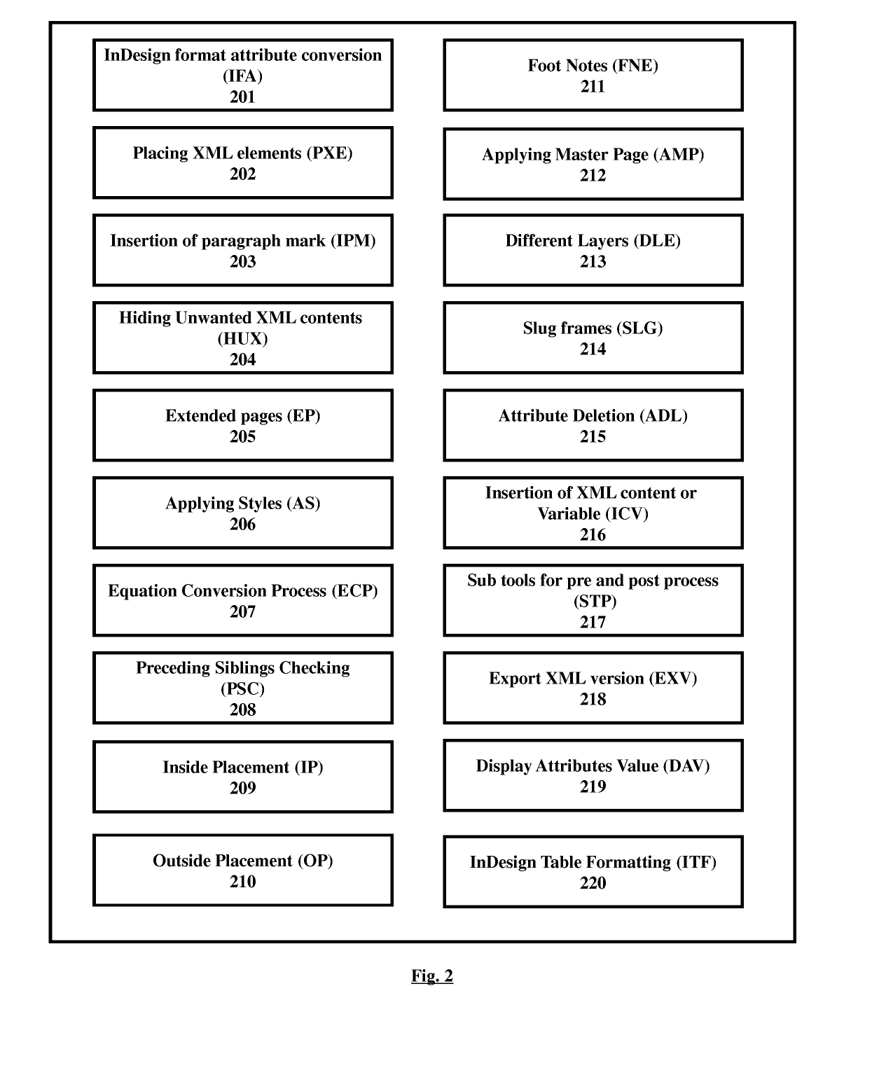

FIG. 2 illustrates a broad block diagram that shows various pagination processes selected during DBInXML execution as disclosed in the embodiments herein. The various processes listed under the DBInXML execution are InDesign format attribute conversion (IFA) 201, Placing XML elements (PXE) 202, Insertion of Paragraph Mark (IPM) 203, Hiding Unwanted XML Contents (HUX) 204, Extended Pages (EP) 205, Applying Styles (AS) 206, Equation Conversion Process (ECP) 207, Preceding Sibling Checking (PSC) 208, Inside Placement (IP) 209, Outside Placement (OP) 210, Foot Notes (211), Applying Master Page (AMP) 212, Different Layers (DLE) 213, Slug Frames (SLG) 214, Attribute Deletion (ADL) 215, Insertion of XML content or variable (ICV) 216, Sub tools for pre and post process (STP) 217, Export XML version (EXV) 218, Display Attributes Value (DAV) 219 and InDesign Table Formatting (ITF) 220. The above pagination processes are selected from a vast list of pagination processes presented to the user by default, the user can select the required/relevant processes as needed for a document or based on customer preferences. In some embodiments, user may also be allowed to create various profiles with combination of different processes. The user can then directly select a profile instead of selecting processes each time.

IFA 201 is a process of converting images, which require conversion, to supporting formats in an InDesign document. PXE 202 is a process of placing a given XML element in specified text frame in InDesign document. IPM 203 is a process of inserting paragraph mark in a document. HUX 204 is a process of hiding unnecessary contents in an InDesign document from display view. EP 205 is a process, which is done when there is more content in XML file than which can be fit in a file. AS 206 is a process of applying styles for paragraph, character, list, group and table. ECP 207 is used for converting MathML code to MathMagic/InMath/PowerMath equation. PSC 208 checks if the preceding and sibling elements are in same page or line. PSC 208 further moves the elements to be in same page or line if they are not in the same page or line. IP 209 is the process to do floating placement of figure, table and library items. OP 210 is done for floating placement of side notes and marginal notes. FNE 211 is the process of inserting footnotes in a document. AMP 212 is for applying different Master Pages in a document. In an embodiment, a Master Page is a building block page that can be used as a background. DLE 213 is for placing element content in different layers. SLG 214 is for flowing the overflowed text to slug area. ADL 215 is used to delete unwanted attributes from InDesign document. ICV 216 is to insert XML element content or variable in InDesign. STP 217 refers to sub tools such as executable, scripts and XSLT that are executed on XML file. EXV 218 is for exporting InDesign document to XML format in specified XML version. DAV 219 is to display attribute value in document for cross-reference. ITF 220 is for formatting tables in a document.

In an embodiment, in DBInXML run various pagination processes are selected by user according to requirement in any sequence. This could be based on the sequence of displayed XPaths and the way user maps the processes to XPath as per his preference. Further, User can select whichever processes (in any combination) required as per his requirement in DBInXML run.

In another embodiment, in InXML run various processes are executed in sequence by application. For example ‘Applying Styles’ (AS) process will happen only after ‘Hiding Unwanted XML element’ (HUX) process since there is no point in applying styles to hidden content. However, if any of the processes listed in sequence in the flow Chart has not been selected in DBInXML run by the user it will not have a corresponding entry in database (found through querying the database). Then the process is skipped and the next in order is executed.

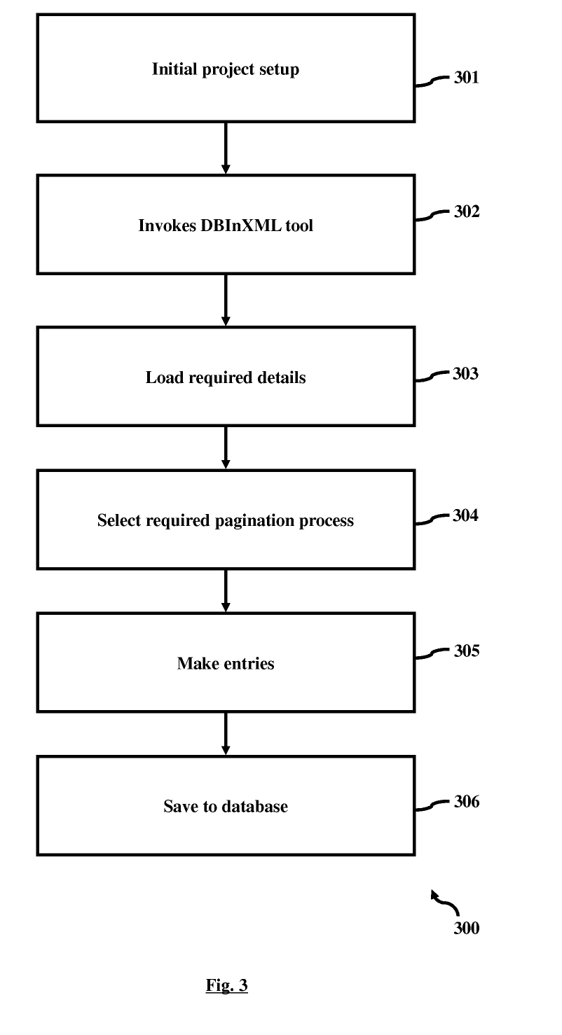

FIG. 3 illustrates a flow diagram which shows the process flow in DBInXML as disclosed in the embodiments herein. In this process, user has to do initial project setups (301). In an embodiment, the initial project setups comprise process of creating required InDesign templates and libraries, creation of InXML standard folder structure, process of placement of XML files and DTDs in source folder and process of placing InDesign template, libraries, XML file with DTDs in corresponding folders. Once the initial setups are done, the DBInXML tool is invoked (302). Then the system loads (303) required details from InDesign template, libraries and XML file using the DBInXML tool. The system provides the user a list of 25 predefined processes available for pagination. User selects (304) required pagination process from the list and makes entries (305) for that particular process to be automated. The user also makes entries regarding the XPATH analyzed. The details are then stored (306) in the database by DBInXML.

In an embodiment, the role of DBInXML tool is elaborated as below. The DBInXML tool when invoked, allows user to select the folder containing XML files, enter the name of the Project, and add templates and libraries if required. (The templates and libraries would have been created earlier based on project's requirements.) Further, in the first run, the XPath information is extracted from input XML file and saved in database. (In subsequent runs the XPath information is retrieved from database). The XPath expressions are displayed one at a time in tree view structure. User can select and view the consecutive XPaths in sequence. For the selected XPath expression, the user has to analyze and select the processes that have to be automated from the 25 predefined processes available. User has to select the processes from the drop down list and give the required inputs. This information is updated in the database. The various actions in method 300 may be performed in the order presented, in a different order or simultaneously. Further, in some embodiments, some actions listed in FIG. 3 may be omitted.

In an embodiment, the process, which is performed by DBInXML tool, is explained below with examples. Consider the example of Applying Styles (AS). The User needs to apply varying styles for different XPath expressions: XPath Expression1: chapter/section/title, user needs to apply H1 style and for XPath Expression2: chapter/section/subsection/title, user needs to apply H2 style.

While executing DBInXML, for the first expression shown in the display XPath window, user will select the Process ‘Applying Styles’ and select Style Type as Paragraph and Style Name as H1. For the second expression in the display XPath window, user will select the Process ‘Applying Styles’ and select Style Type as Paragraph and Style Name as H2. The information regarding XPath, Style type (Paragraph), Style Name etc will be stored in the database by DBInXML. It will be referred during InXML run and used to apply styles in InDesign document.

In another embodiment, the example considers Applying Styles for List type. As shown in below table, in a paragraph containing list items the line spacing could be uneven.

to initiate mist drilling:

1. Unload the mud out of the hole as with air drilling . . .
2. Turn on the mist pump and begin. . .
3. As soon as there are steady returns. . .
4. If too many changes are made. . .
7.2.3 Making . . .

Here the user can select the XPath for the list, select process Applying Styles, specify style type as List and style Name NL1 for items first in list, NL2 for items last in list and NL for items in between. The XPath, Style Type (List), list style etc is updated in the database by DBInXML. It is referred during the InXML run to apply styles to list items in the document. Other style types available are Character Style and Table Style, which are selected and updated and used, in similar fashion.

In another embodiment, the user selects the process of Inside Placement. In this case, floating elements refer to tables and figures within a document that cannot be broken over a page. The placement can be done by positioning the figure at the top of a page, at the bottom of a page, or in the same position it occurs in the source text. The XPath expression corresponding to a particular figure may be for example

/chapter/ce:sections/ce:section/ce:para/ce:display/ce:figure

In DBInXML, user can select for this XPath, process as ‘Inside Placement’, enter the cross reference information and specify placement as ‘Inline’ or ‘Top or Bottom’. This information is updated in database by DBInXML. It is referred during InXML execution and applied for the figure mentioned in the XPath.

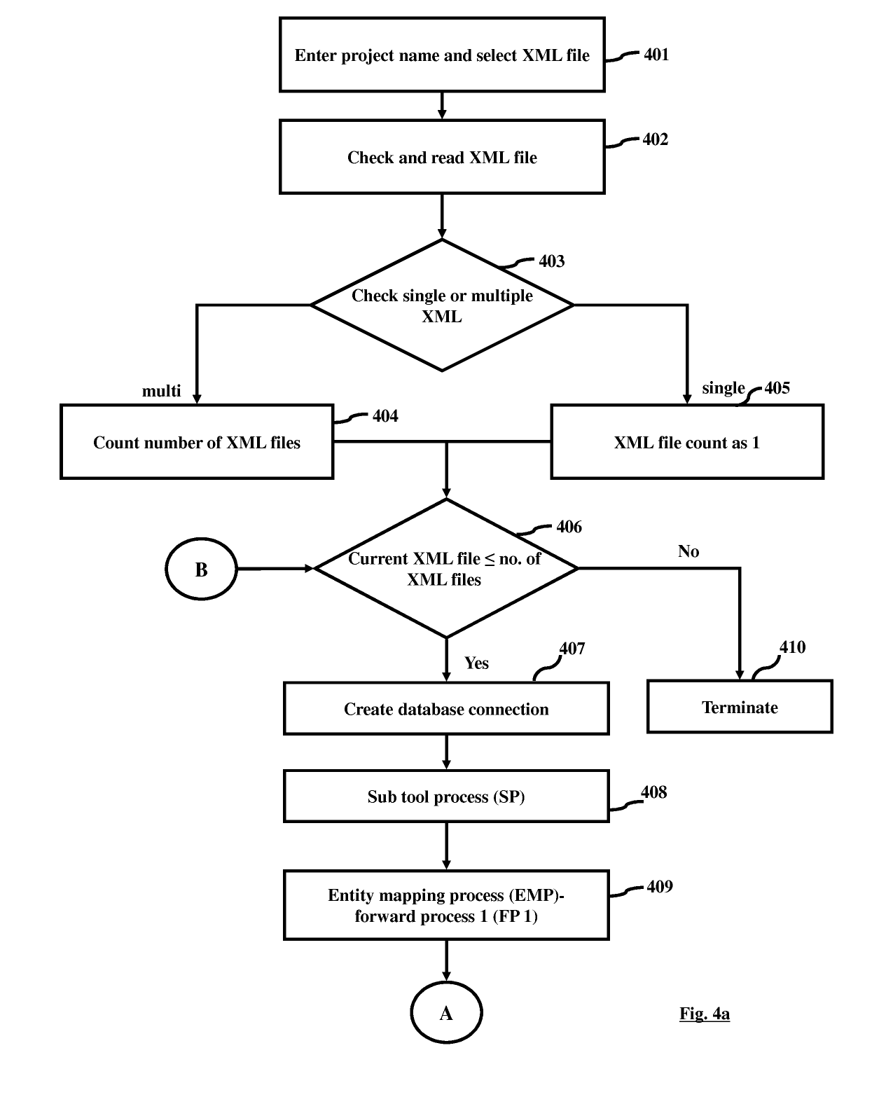

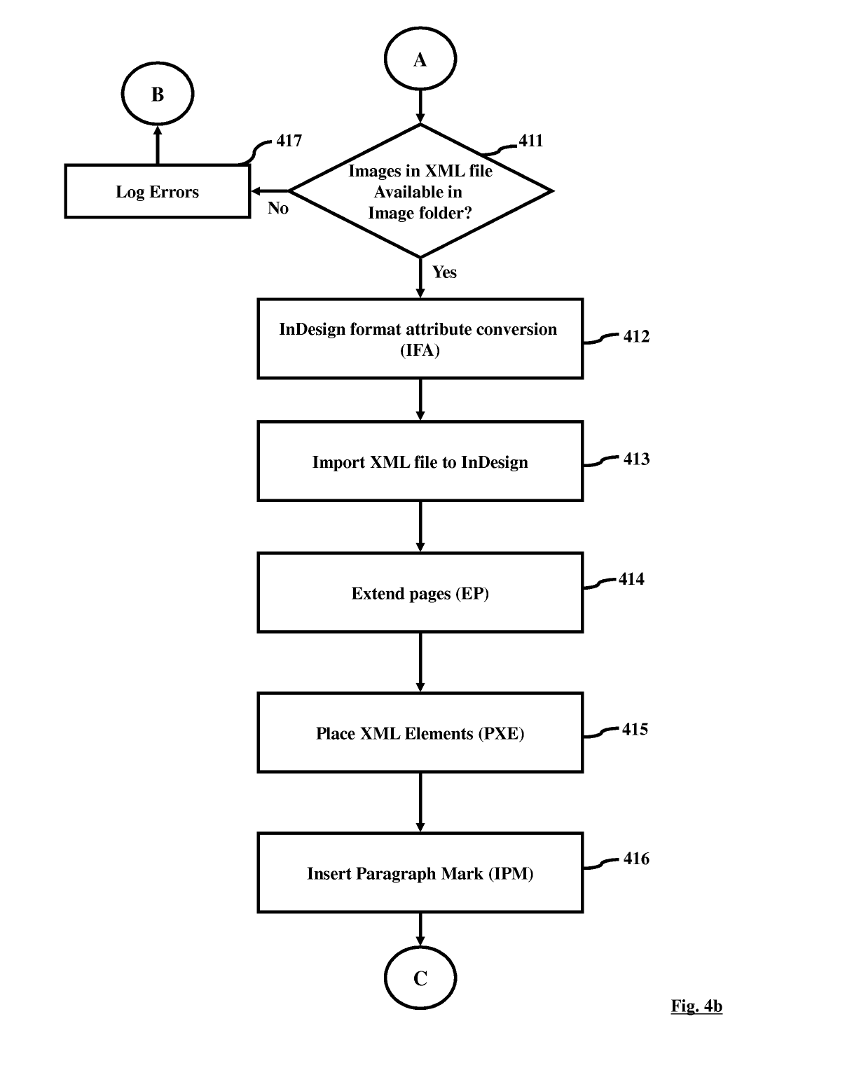

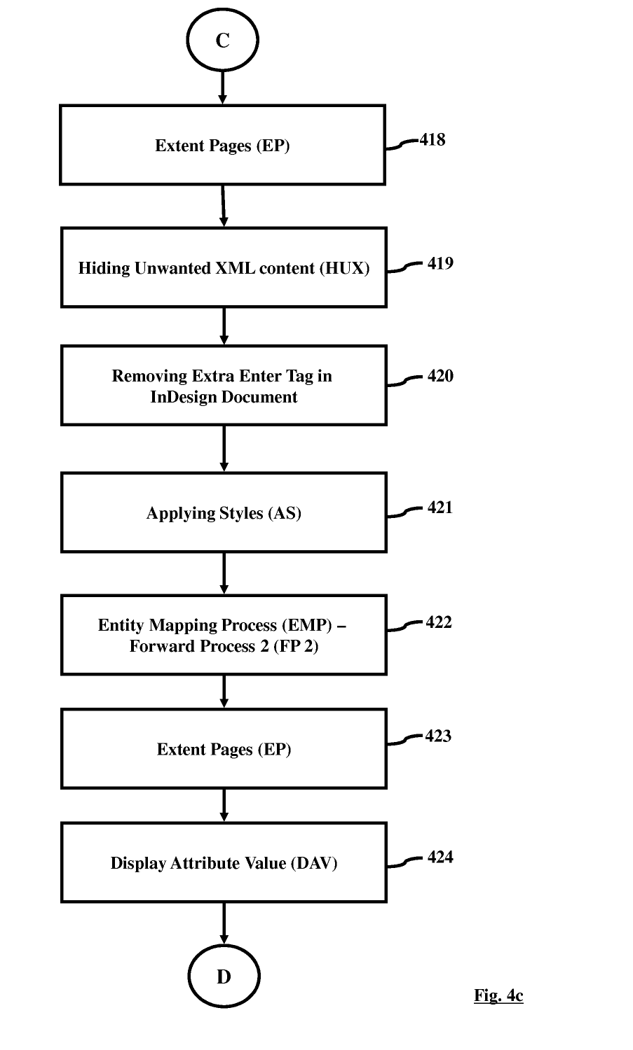

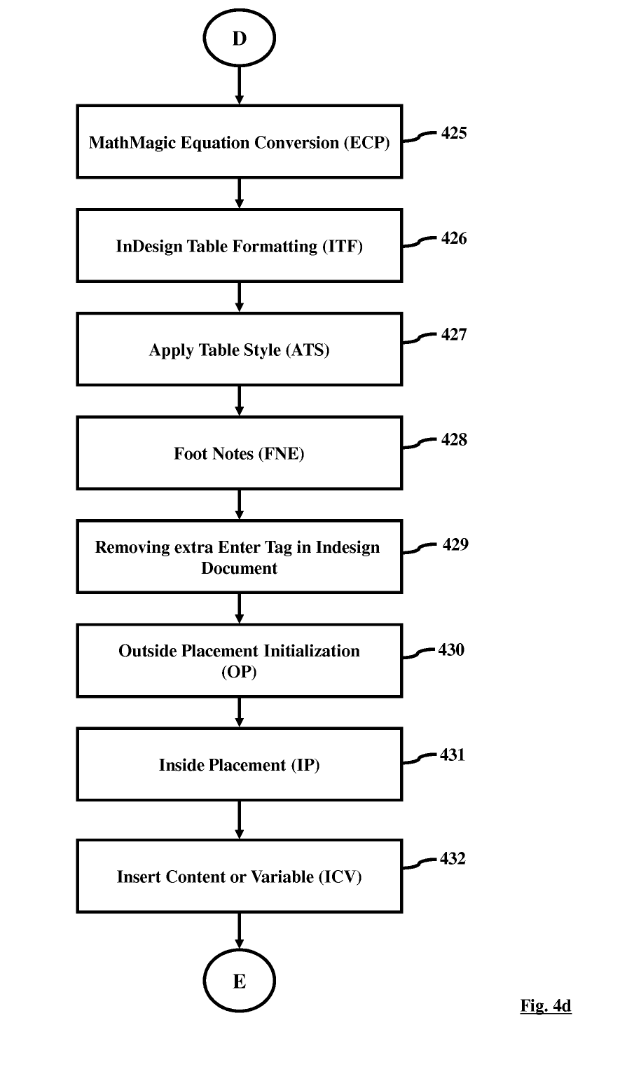

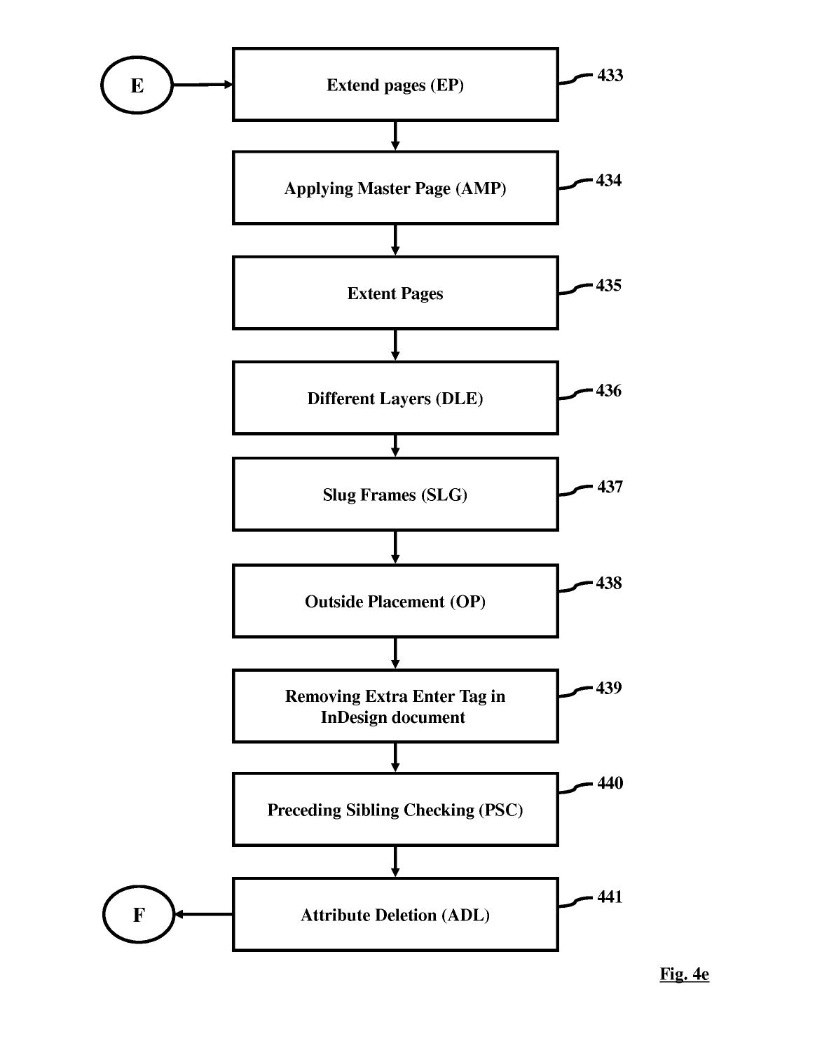

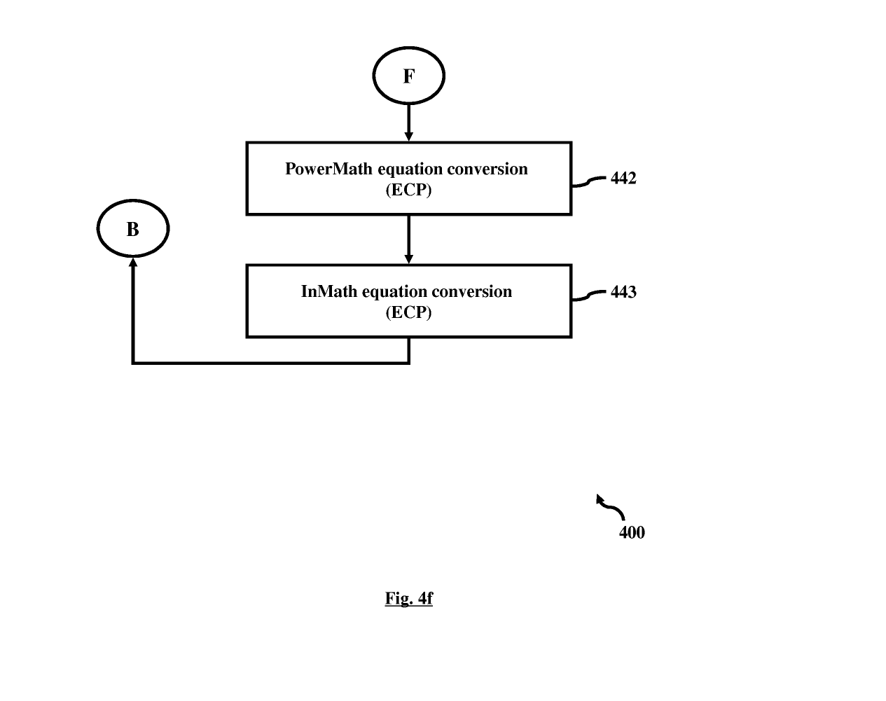

FIGS. 4a-4f are flow diagrams which show a work flow in paginating and converting an XML input file to an InDesign output file as disclosed in the embodiments herein. Initially, the user enters project name and selects (401) XML file from the source file folder. Then the InXML application initiates file checking process during which the application keeps track of number of XML files and establishes connection with the database created by the DBInXML tool. Further, the application reads the XML file. Then the application checks (403) the number of XML files. If there is only one file, the XML file count is assigned (405) as 1. If multiple XML files are present, then the number of XML files is counted (404). Then the application checks (406) if the current XML file is less than or equal to total number of XML files. If the current XML file count is not less than or equal to total number of files, then the XML to InDesign conversion is terminated (410). If the current XML file count is less than or equal to total number of XML files, then the application creates (407) a database connection. In an embodiment, the database connection specified represents connection to the database created as a result of DBInXML run. This is done by selecting the same from the path <ProjectName>/Supporting Files (Refer Folder Structure diagram).

In an embodiment, the database connection is established after the File Checking Process (checking of template, database files etc) is completed during each of the conversions/process such as XML to InDesign, InDesign to Word (With Frame), InDesign to Word (Without Frame), InDesign to Nimas, InDesign to ePUB and Retagging.

Further, sub tools for pre and post processes are executed (408) on XML file. The sub tools are executed for both the forward and reverse processes. In an embodiment, the sub tools executed during pre and post process comprise executable, scripts and XSLT. Then first forward process in entity mapping process (409) is done during which font is applied for symbols or some special characters. Then the application checks (411) if the images in XML file are available in image folder. If the images are not available, then the errors are logged (417) and control goes to 406. If images in XML file are available in image folder, then the application converts (412) attributes requiring conversion to supported format using InDesign Format Attribute (IFA) Conversion process. Then the XML file is imported (413) to InDesign and the pages are expanded (414) if required. In an embodiment, the process of Expanding Pages is done (414) when there is more content in XML file than which can be fit in a file. In another embodiment, information regarding text frame label name specified for master page is retrieved from database and is used to extent pages. Then the given XML element is placed (415) in a specific text frame in the InDesign document. In the next step, the application inserts (416) paragraph marks in the document. The pages are then extended (418) and the application hides (419) the unwanted XML contents in the document. The application then removes (420) extra enter tags in the InDesign document and applies (421) styles for paragraph, character, list, group and table. The application then performs (422) second forward process in entity mapping. The pages in document are then extended (423) and attribute values are displayed (424). Then equation conversion process takes place (425) during which MathML equation is converted in to another form. In an embodiment, the MathML equation can be converted to any or all forms like MathMagic, InMath, PowerMath etc.

The application then formats (426) the tables present in the document and applies (427) the table styles. In the next step, footnotes are inserted (428) to the document. Then the extra enter tags in InDesign document are removed (429) and the Outside Placements are initialized (430). Then using the Inside Placement (431), floating placement of figure, table and library items is done. XML element contents and text variables are then inserted (432) to the InDesign document. The pages in the document are then extended (433) and master page is applied (434). In an embodiment, a master page is a building block page that can be used as a background. The pages of document are again extended (435) and element contents are then placed (436) in different layers. Slug frames are then used (437) to flow overflowed text to slug area. Floating placement of side notes and marginal notes are then done using outside placement (438). The extra enter tags in the document are then removed (439). Further, the application checks (440) if the preceding and sibling elements are in the same page or line. In an embodiment, if the preceding and sibling elements are not in same line/page, the application moves the elements such that the elements come in a single line or page. Then the application deletes (441) unwanted attribute from InDesign document. The various pagination processes in method 400 may be performed in the order presented, in a different order or simultaneously. Further, in some embodiments, some of the pagination processes listed in FIGS. 4a-4f may be omitted.

In an embodiment, InXML has been developed to augment InDesign's XML capabilities. In case of XML to InDesign (Forward Process) the following sequence of steps occur. Before importing XML file to InDesign (Refer Workflow Diagram—XML to InDesign) the sub tools process (e.g. to make MathML in XML file compatible for PowerMath Plug-In of InDesign), entity mapping process (e.g. to map mathematical symbols entities as per Mathematical Pi Character Mapping Standard and make it compatible for Mathematical Pi font style of InDesign) and Format Attribute conversion (changing figure links to be recognizable by InDesign) processes takes place. After import of XML file and flowing it into corresponding text frames the other processes required for pagination (selected by user in DBInXML execution such as hiding unwanted XML element, Applying Styles etc) are automatically executed in sequence. The final result will be InDesign file with pagination completed.

In case of InDesign to XML (Reverse Process) the following sequence of steps occur. The Adobe InDesign document with pagination completed is converted back to XML document. This is to make all edits during the proof passes reflected in the XML file thus supporting a unified XML workflow. If the user had selected process Export XML version (EXV) or Equation Conversion Process (ECP) then the additional inputs (XML version and entries pertaining to equation conversion) will be present in database. From above (if present) and the information regarding the forward process the required reversal processes take place to deliver the XML file. Further, Export of InDesign to NIMAS XML may be performed. The InDesign is converted to XML as explained above and XML is converted to NIMAS XML. For Export of Adobe InDesign to ePUB Adobe InDesign document is converted to XML as explained above, XML is converted to HTML and HTML is converted to ePUB. For export of Adobe InDesign to Word With Frame: Adobe InDesign document is converted to Word document without any changes in the frames, layouts, styles etc. For export of Adobe InDesign to Word Without Frame: Adobe InDesign document is converted to Word document by retaining only styles.

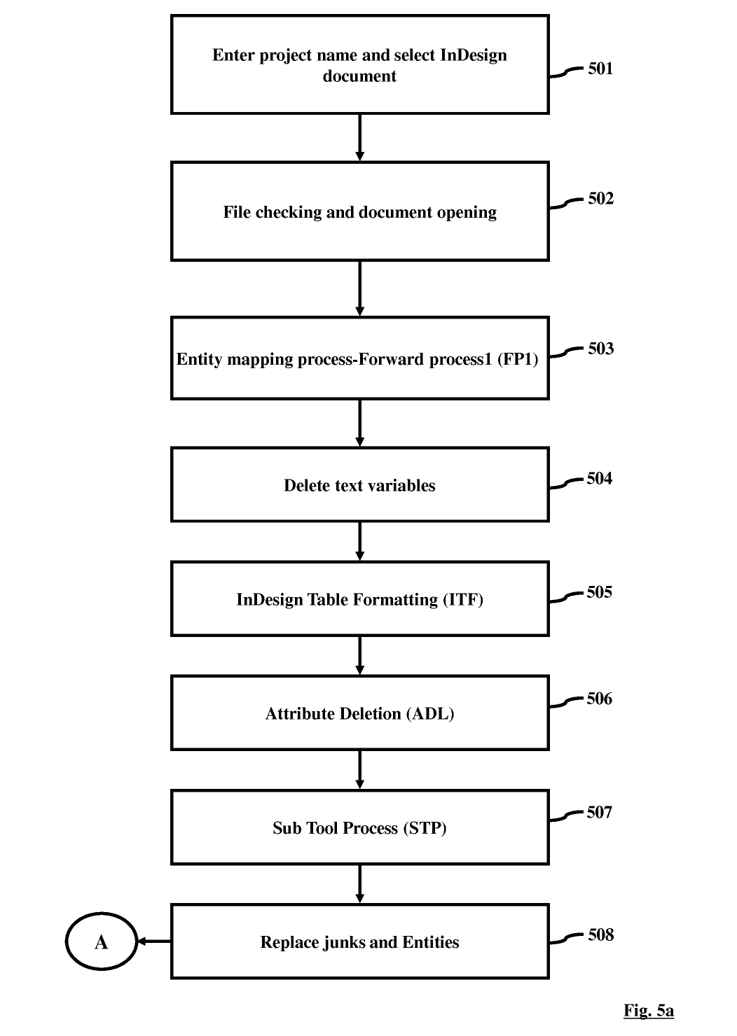

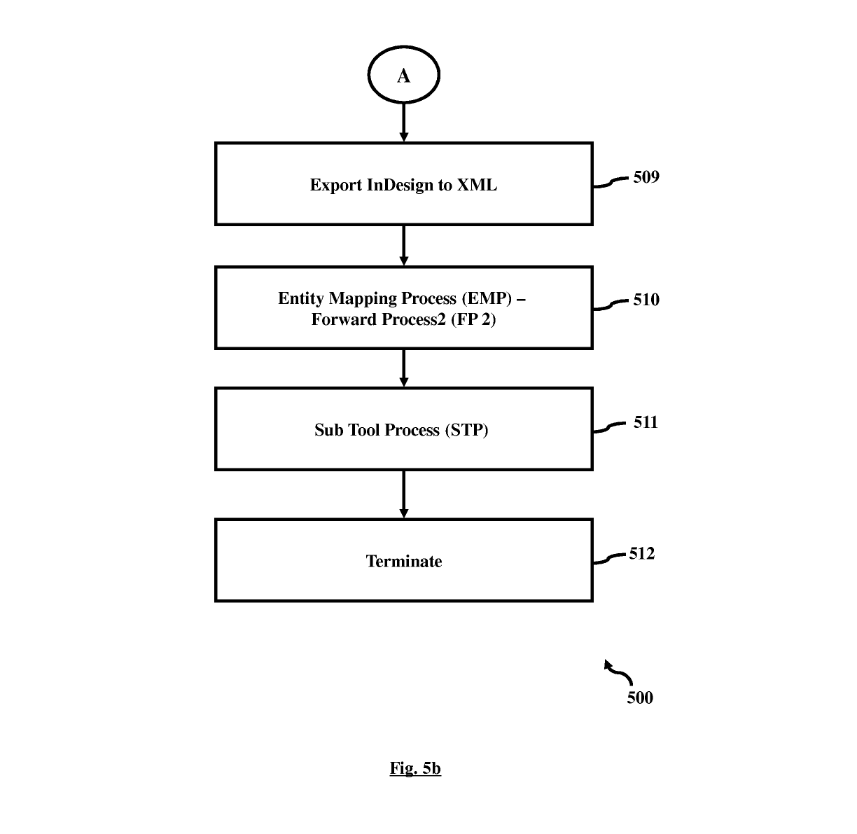

The InDesign document created by the InXML tools can be converted reliably to other formats. FIG. 5a to FIG. 8b show different flow diagrams explaining conversion of an Indesign document to different formats as disclosed in the embodiments herein.

FIGS. 5a-5b are flow diagrams, which show the process of converting InDesign to XML as disclosed in the embodiments herein. This is a reverse process. Initially, the user enters a project name and selects (501) an InDesign document from the application folder. The application then perform the file checking process (502) during which various attributes such as entity file, database etc are checked. Further, the application opens the InDesign document. Then the application performs the first forward process (FP1) in the entity mapping process (EMP) (503) during which fonts are applied for symbols and/or special characters present in the document. Further, the text variables present in the document are deleted (504). The tables present in the document are then formatted to XML by the application (505). Further, the unwanted attributes in the document are deleted (506) by the application. Then the sub tools are executed (507) in the XML file and the junks and entities are replaced (508). Further, the application exports (509) InDesign document to XML. Then the application applies (510) fonts for symbols and/or special characters present in the document during the second forward process of entity mapping. The sub tools are again executed in the XML file and then the process is terminated (511). The various actions in method 500 may be performed in the order presented, in a different order or simultaneously. Further, in some embodiments, some actions listed in FIGS. 5a-5b may be omitted.

In an embodiment, reverse conversion processes may also be followed. For example, for conversion of Adobe InDesign to XML the processes which were performed while converting XML to Adobe InDesign are performed in the reverse sequence as described below. At first, the Entity Mapping Process—Reverse Process 1 occurs. The variables inserted as part of ICV or DAV process are deleted. The process of applying InDesign Table formatting is reversed. The attributes that were deleted as part of ADL process are reinserted. The Sub Tool Process—Reverse Pre Process occurs. The junk and other entities are replaced using supporting files such as entity.hex. The InDesign document is exported as XML document. The Entity Mapping Process—Reverse Process 2 occurs. The Sub Tool Process—Reverse Post Process occurs. The reverse process has two additional inputs. 1. XML version and 2. Entries (like XPath input) regarding equation conversion. The database will contain the same information captured in Forward Process plus the information regarding additional inputs. This will be retrieved and used by InXML tool in reverse process. This is necessary so that InXML tool will know how to reverse the processes pertaining to InDesign to get XML.

An example could be an Adobe InDesign process created by the forward process for which the encoding format of XML (to be created by reverse process) required could be UTF-16. The input regarding the XML encoding format will be given as user input. The database will contain both the information used for the forward process plus this input. After the reversals, instead of the default encoding format (UTF-8) being used in the conversion of InDesign to XML, UTF-16 format is used.

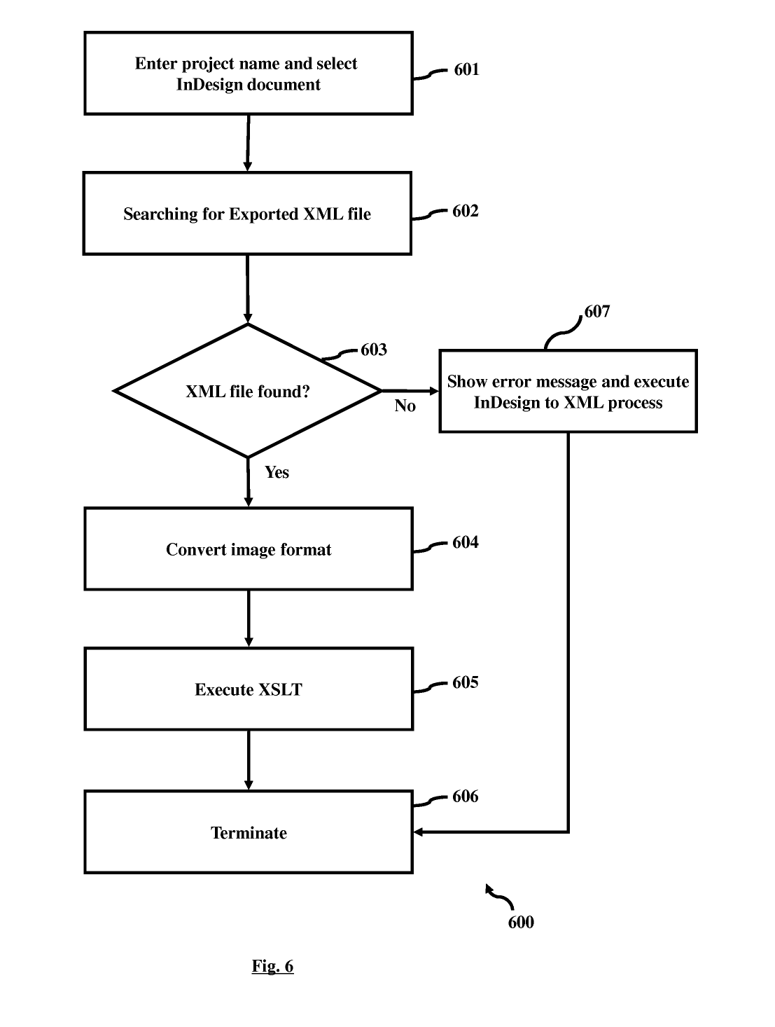

FIG. 6 is a flow diagram, which shows the process of converting InDesign to NIMAS XML as disclosed in the embodiments herein. Initially, the user enters project name and selects (601) the document to be converted from the application folder. The application then searches (602) for the required XML file in the “Final XML” folder, the application checks (603) if the XML file is found or not. If the XML file is not found, an error message is generated and InDesign to XML conversion process is executed (607). In an embodiment, the error message may be “XML file is not found on final folder” or any such message that can convey the message that the search for XML file did not retrieve any document. If the XML file is found, the images are initially converted (604) to a suitable format. In an embodiment, the image may be converted to a “GIF” format or any such appropriate image formats. Then the application executes (605) XSLT. In an embodiment, XSLT is XML to NIMAS XML conversion. Once the XML to NIMAS XML conversion is finished, the process is terminated (606). The various actions in method 600 may be performed in the order presented, in a different order or simultaneously. Further, in some embodiments, some actions listed in FIG. 6 may be omitted.

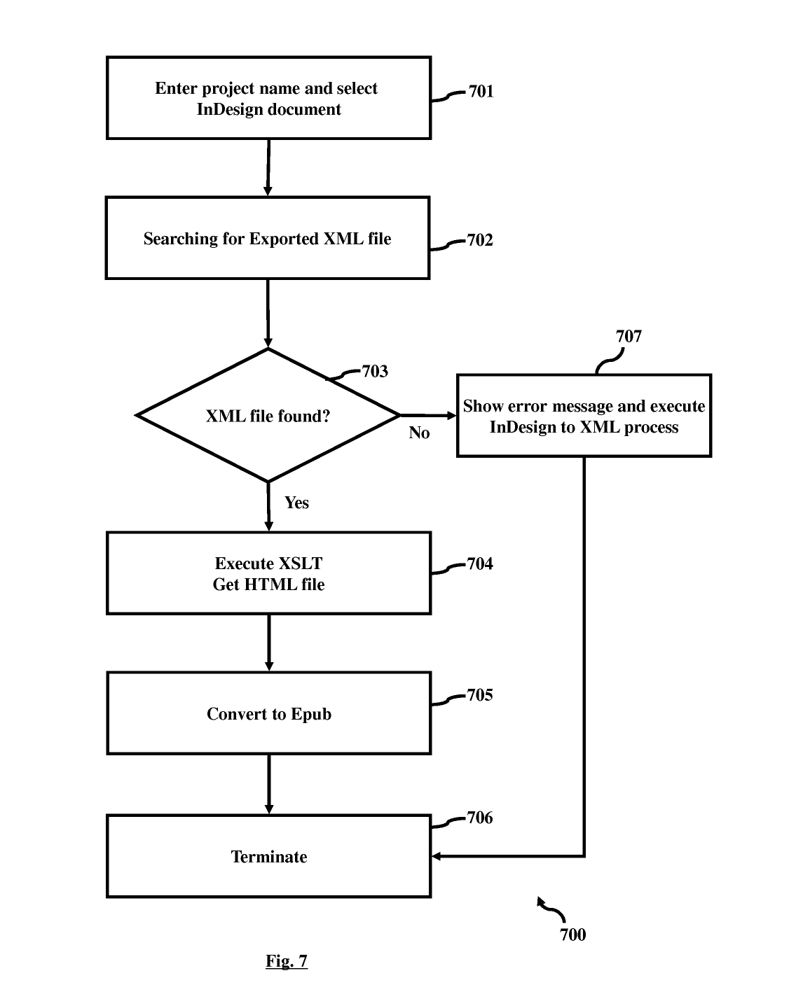

FIG. 7 is a flow diagram, which shows the process of converting InDesign to EPub as disclosed in the embodiments herein. Initially, the user enters project name and selects (701) the document to be converted from the application folder. The application then searches (702) for the required XML file in the “Final XML” folder, the application checks (703) if the XML file is found or not. If the XML file is not found, an error message is generated and InDesign to XML conversion process is executed (707). In an embodiment, the error message may be “XML file is not found on final folder” or any such sentence that can convey the message that the search for XML file did not retrieve any document. If the XML file is found, HTML file is obtained by performing conversion (704). Once the HTML file is obtained, then the HTML file is converted to EPub by performing another conversion process (705). Then the conversion process is terminated (706). The various actions in method 700 may be performed in the order presented, in a different order or simultaneously. Further, in some embodiments, some actions listed in FIG. 7 may be omitted.

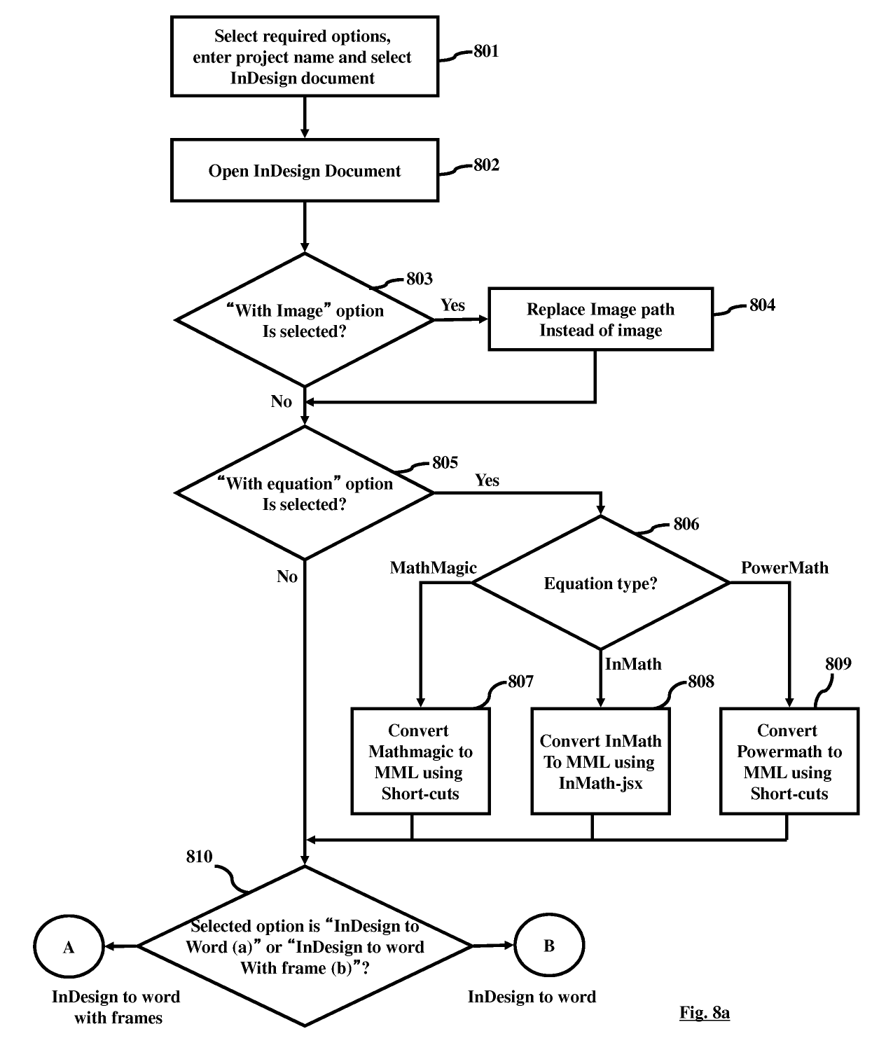

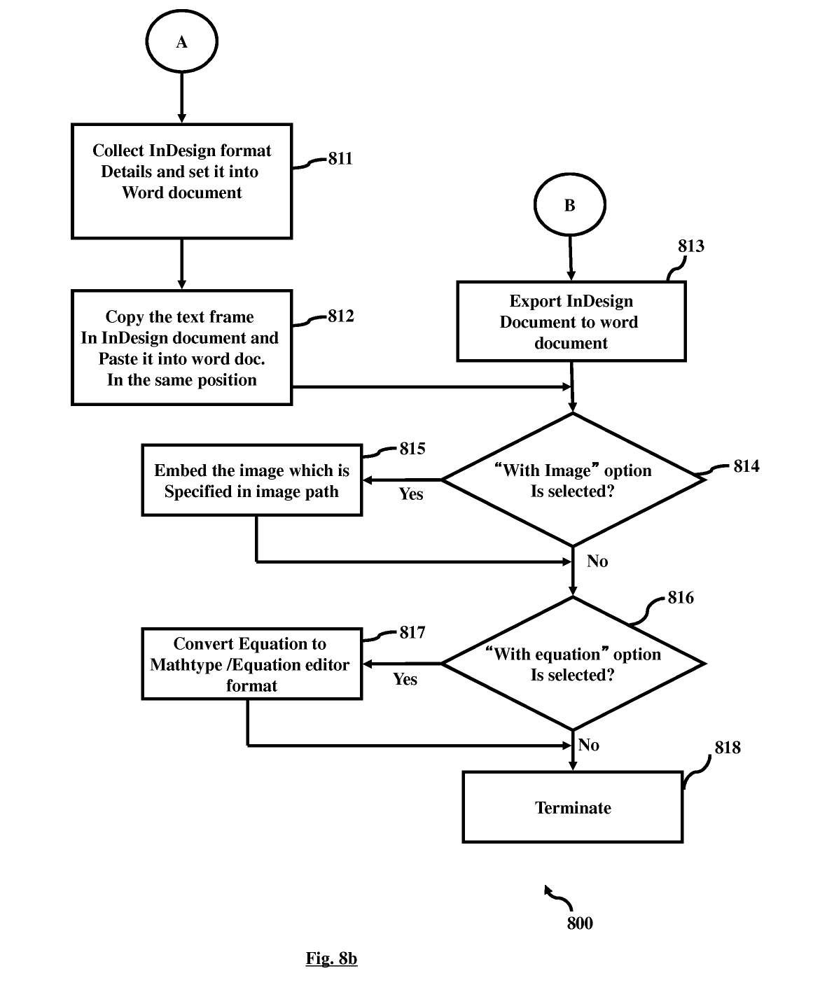

FIGS. 8a-8b are flow diagrams, which show the process of converting InDesign to Word as disclosed in the embodiments herein. Initially, the user selects (801) required options, enter project name and select the InDesign document to be converted from application folder. The application then opens (802) the selected InDesign document and checks (803) if the “with image” option is selected. If “with image” option is selected, then image is replaced (804) with image path, else control goes to 805. If “with image” option is not selected in 803, then the application checks (805) if “with equation” option is selected. If “with equation” option is selected, then the application checks (806) the type of equation. If “with equation” option is not selected, then control goes to 810. If the equation type is “MathMagic”, then the MathMagic equation is converted (807) to MathML equation. If the equation is of InMath type, InMath equation is converted to MathML. If the equation is of “PowerMath” type, PowerMath equation is converted to MathML. Once the conversion is over, the application checks (810) if the user selected option is “InDesign to word” or “InDesign to word with frames”. If “InDesign to word with frames” option is selected, then the InDesign format details are collected (811) and are set into a word document. Then the text frame in InDesign document are copied and is pasted (812) into word document in the same position and control goes to 814. If in 810, “InDesign to word” option is selected, then InDesign document is exported to word document (813) and the application checks (814) if “with image” option is selected by the user. If “with image” option is selected, then image that is present in the specified image path is embedded (815) in the document and control goes to 816. If in 814, “with image” option is not selected, then the application checks (816) if “with equation” option is selected. If “with equation” option is selected, then MathML equation is converted (817) into MathType and the process is terminated (818). If in 816, “with equation” option is not selected, the process is directly terminated (818). The various actions in method 800 may be performed in the order presented, in a different order or simultaneously. Further, in some embodiments, some actions listed in FIGS. 8a-8b may be omitted.

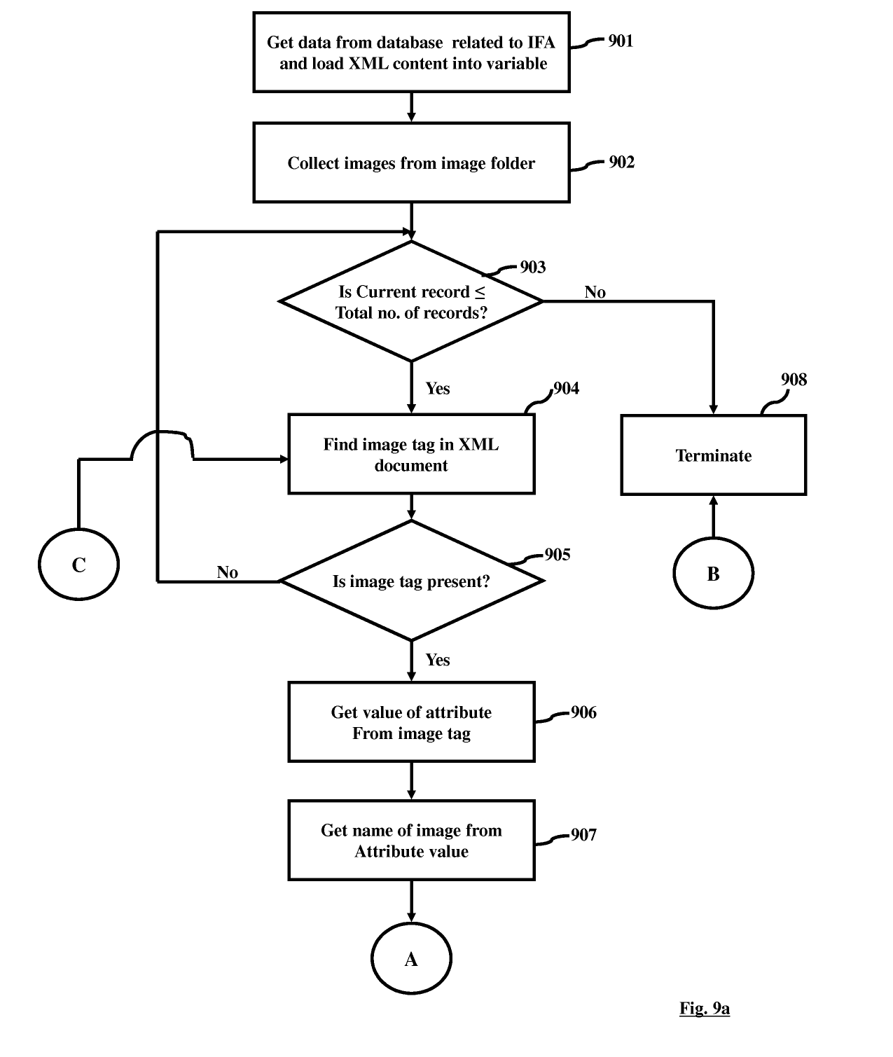

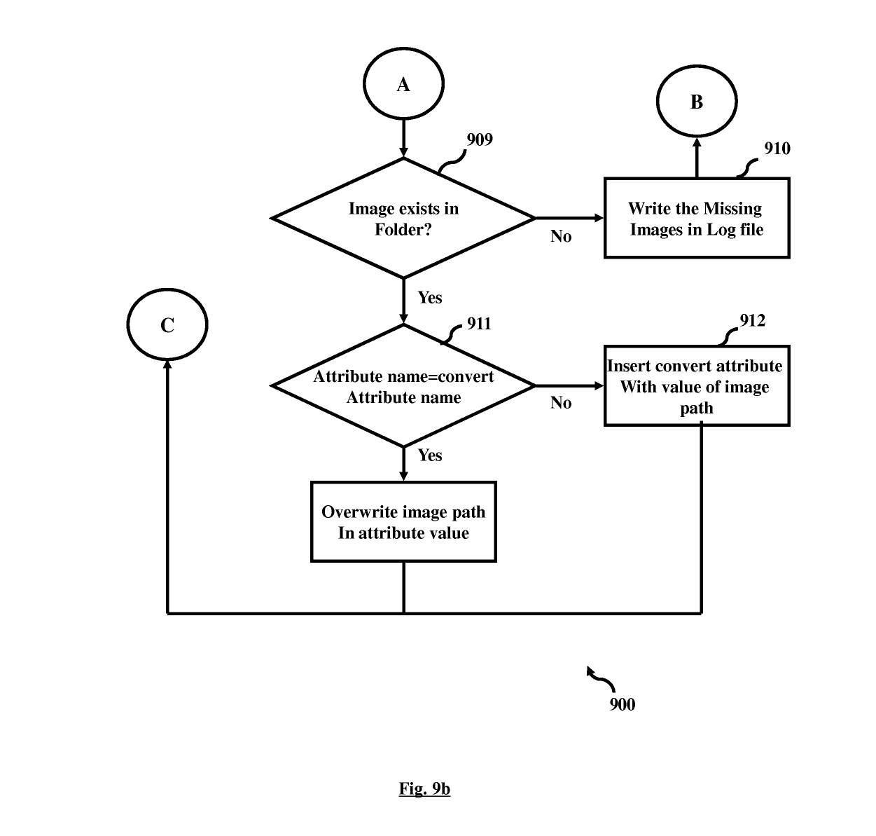

FIG. 9a to FIG. 32 show flow diagrams of pagination processes listed in FIG. 2 disclosed in the embodiments herein. FIGS. 9a-9b are flow diagrams which show the process of InDesign Format Attribute Conversion (IFA) as disclosed in the embodiments herein. In XML file, figure links are formed based on DTD's specification. The process of formation of figure links based on DTD specification is not supported in InDesign. The present system uses InDesign Format Attribute Conversion (IFA) so as to convert attributes to a desired format. IFA replaces attributes that specifies destination of a link by an attribute value which is interpreted as a literal path name and places the XML in an InDesign document.

Initially, the application tries to fetch (901) data from database which matches the specified type and tag. In an embodiment, the application fetch data from the database with Type=“ANC” and Tag=“FLC”. Further the application loads XML content into variable. Then the application collects (902) images from image folder. In an embodiment, the images are placed in a folder specified as path name. Further, the file names and format in the folder should match with the details specified in XML. Then the application checks (903) if the current record is less than the total number of records. If not, then the process is terminated (908). If the current record is less than the total number of records, then the application tries to find (904) image tag in XML document and checks (905) if the image tag is found or not. If the image tag is not found, control goes to 903. If the image tag is found, then attribute value is obtained (906) from the image tag and then the name of image is obtained (907) from the attribute value. Then the application checks (909) if the image exists in the folder. If the image is not present in the folder, then log file is accordingly filled (910) and the process is terminated (908). If the image exists in the folder, then the application checks (911) if attribute name is same as convert attribute name. If attribute name and convert attribute are not same, then value of image path is inserted into convert attribute and control goes to 904. If attribute name and convert attribute name are same, then image path is overwritten in attribute value and the application continue image find (904). The various actions in method 900 may be performed in the order presented, in a different order or simultaneously. Further, in some embodiments, some actions listed in FIGS. 9a-9b may be omitted.

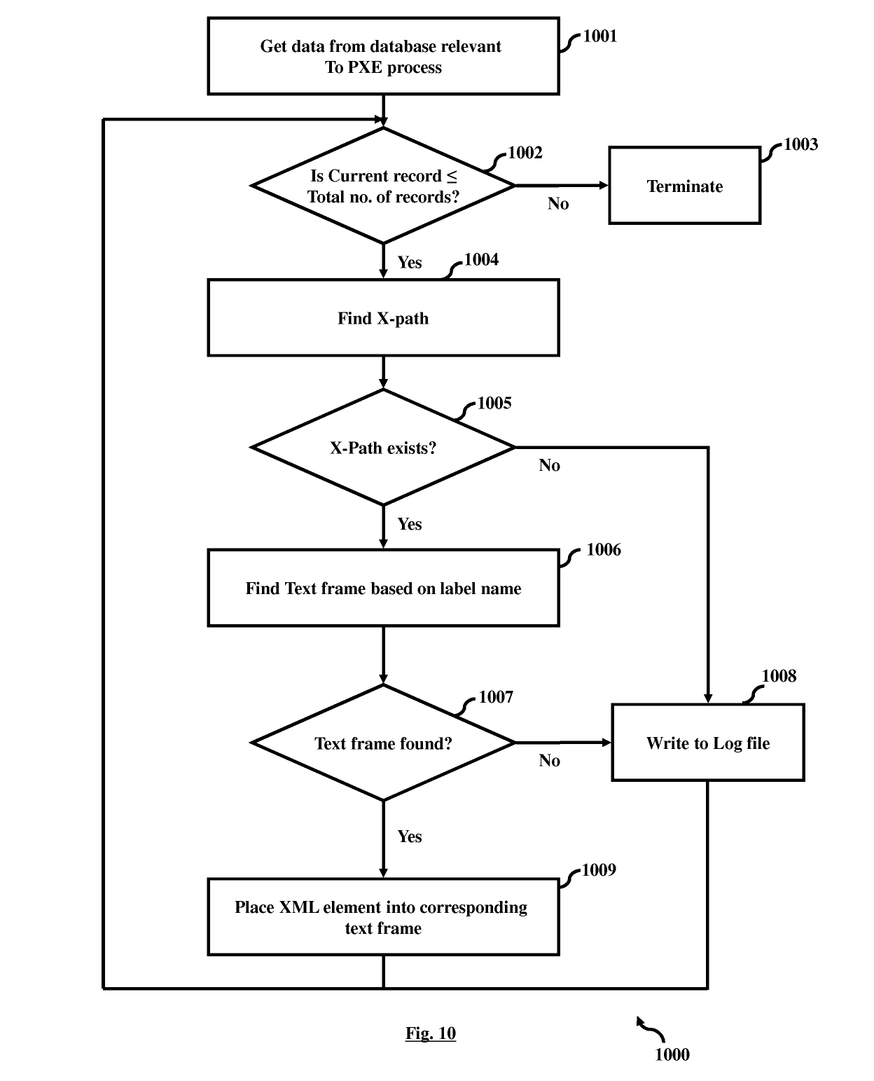

FIG. 10 is a flow diagram which shows the process of placing XML element in Adobe InDesign Document (PXE) as disclosed in the embodiments herein. The application initially fetches (1001) data from database. In an embodiment, the application fetches data of a specific type. In another embodiment, the data is of type “PXE”. Then the application checks (1002) if the current record is less than or equal to total number of records. If the current record is not less than or equal to total number of records, then the process is terminated (1003). If the current record is less than the total number of records, then the application tries to find out (1004) XPath and checks (1005), if the XPath exists or not. If XPath does not exist, then corresponding entry is made (1008) in Log file and proceed with the next record (1002). If XPath is found, then the application tries to find (1006) text frame. In an embodiment, the application tries to find text frame based on label name, the application checks (1007) if the text frame is found or not. If the text frame is not found, corresponding entry is made on the log file and proceed with the next record (1002). If text frame is found, XML element is placed (1009) into corresponding text frame and the process is repeated with next record (1002). The various actions in method 1000 may be performed in the order presented, in a different order or simultaneously. Further, in some embodiments, some actions listed in FIG. 10 may be omitted.

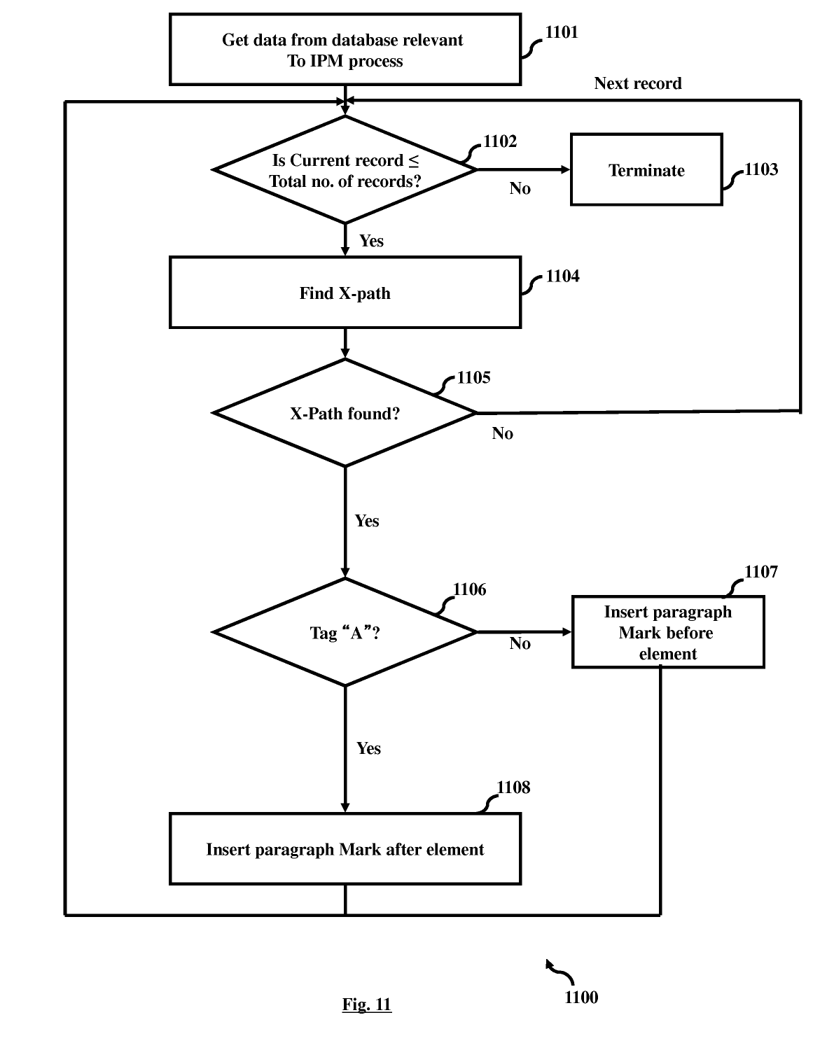

FIG. 11 is a flow diagram, which shows the process of insertion of paragraph mark (IPM) in the document as disclosed in the embodiments herein. InXML removes all paragraph marks from XML before importing the XML file. After import of XML file, paragraph marks are inserted based on existing XML tags using a process IPM.

The application initially fetches (1101) data from database. In an embodiment, the application fetches data of a specific type. In another embodiment, the data is of type “IPM”. Then the application checks (1102) if the current record is less than total number of records or not. If the current record is not less than or equal to total number of records, then the process is terminated (1103). If the current record is less than the total number of records, then the application tries to find out (1104) XPath and checks if Xpath is found (1105) after a particular time period, if the XPath exists or not. If XPath does not exist, then proceed with the next record (1102). If XPath is found, then the application checks (1106) if tag matches with a specified tag. In an embodiment, the tag specified is “A”. If tag is “A”, the paragraph mark is inserted (1108) after the element and the application tries to find out next XPath (1104). If tag is not “A”, the paragraph mark is inserted (1107) before the element and the application proceeds with the next record. The various actions in method 1100 may be performed in the order presented, in a different order or simultaneously. Further, in some embodiments, some actions listed in FIG. 11 may be omitted.

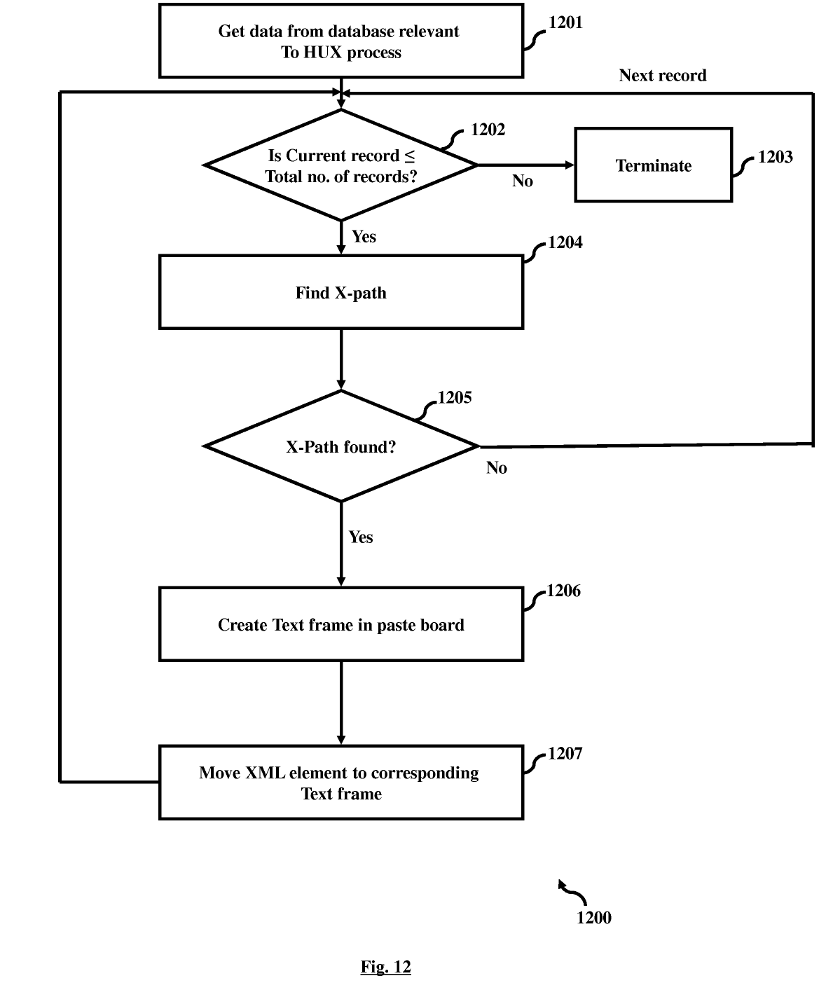

FIG. 12 is a flow diagram, which shows the process of Hiding Unwanted XML contents in the document as disclosed in the embodiments herein. XML file may contain some tags related to metadata information. The tags related to metadata information are not apt in InDesign documents. Unwanted contents in the XML document can be hidden using HUX process in InXML tool. During HUX process, the contents to be hidden are moved to paste board area without deleting so that the hidden information can be retrieved easily when needed.

The application initially fetches data from database. In an embodiment, the application fetches (1201) data of a specific type. In another embodiment, the data is of type “PXE”. Then the application checks (1202) if the current record is less than or equal to total number of records. If the current record is not less than or equal to total number of records, then the process is terminated (1203). If the current record is less than the total number of records, then the application tries to find out (1204) XPath and checks (1205), if the XPath exists or not. If XPath does not exist, proceed with the next record (1202). If XPath is found, then the application create (1206) text frame in paste board and moves (1207) XML element to corresponding text frame. Once the XML element is moved to corresponding text frame, the application tries to find out (1204) the next XPath. The various actions in method 1200 may be performed in the order presented, in a different order or simultaneously. Further, in some embodiments, some actions listed in FIG. 12 may be omitted.

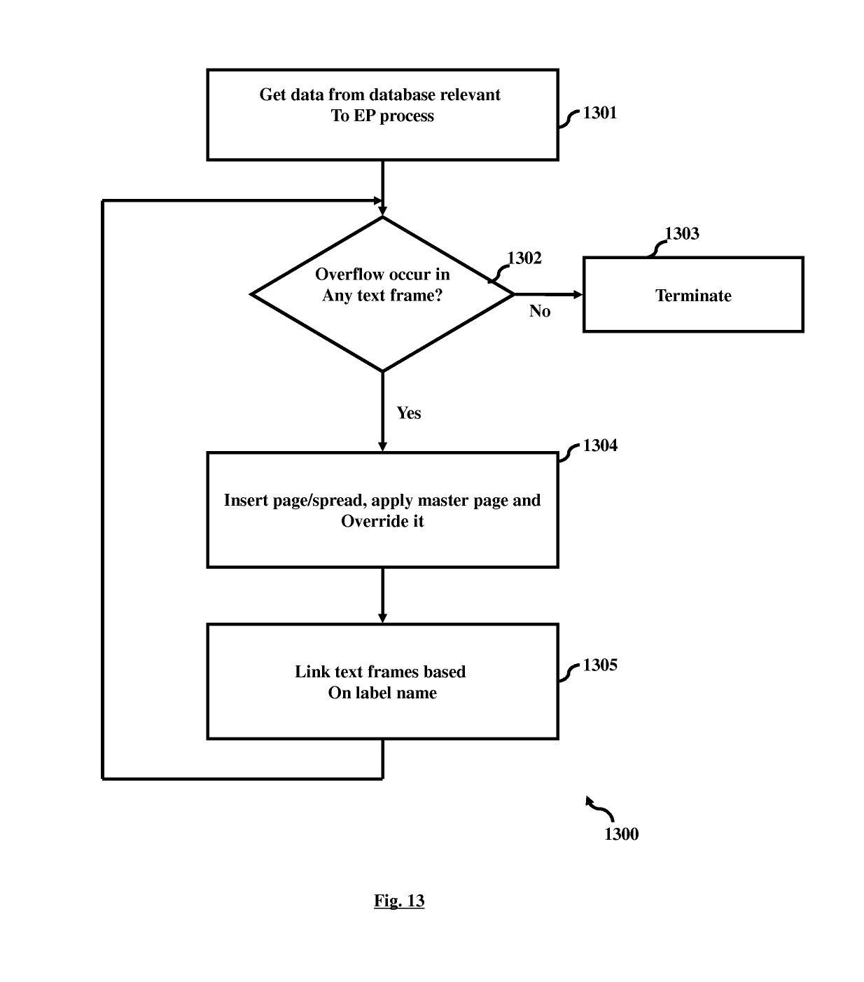

FIG. 13 is a flow diagram, which shows the process of extending pages in document as disclosed in the embodiments herein. In an XML file, when more content is there that can be fit into a InDesign file, EP facility can be used to move contents to another frame. In an embodiment, link can be established between multiple frames. In another embodiment, information regarding text frame label name specified for master page is retrieved from the database and is used for extending pages.

The application initially fetches data from database. In an embodiment, the application fetches (1301) data of a specific type. In another embodiment, the data is of type “MLD”. Then the application checks (1302) if overflow is occurring in any text frame. If no overflow is occurring in any text frame, the process is terminated (1303). If overflow is occurring in any text frame, the application initially inserts page/spread. Further, master page is applied and is overridden (1304). Then the text frames are linked (1305) based on label name. The various actions in method 1300 may be performed in the order presented, in a different order or simultaneously. Further, in some embodiments, some actions listed in FIG. 13 may be omitted.

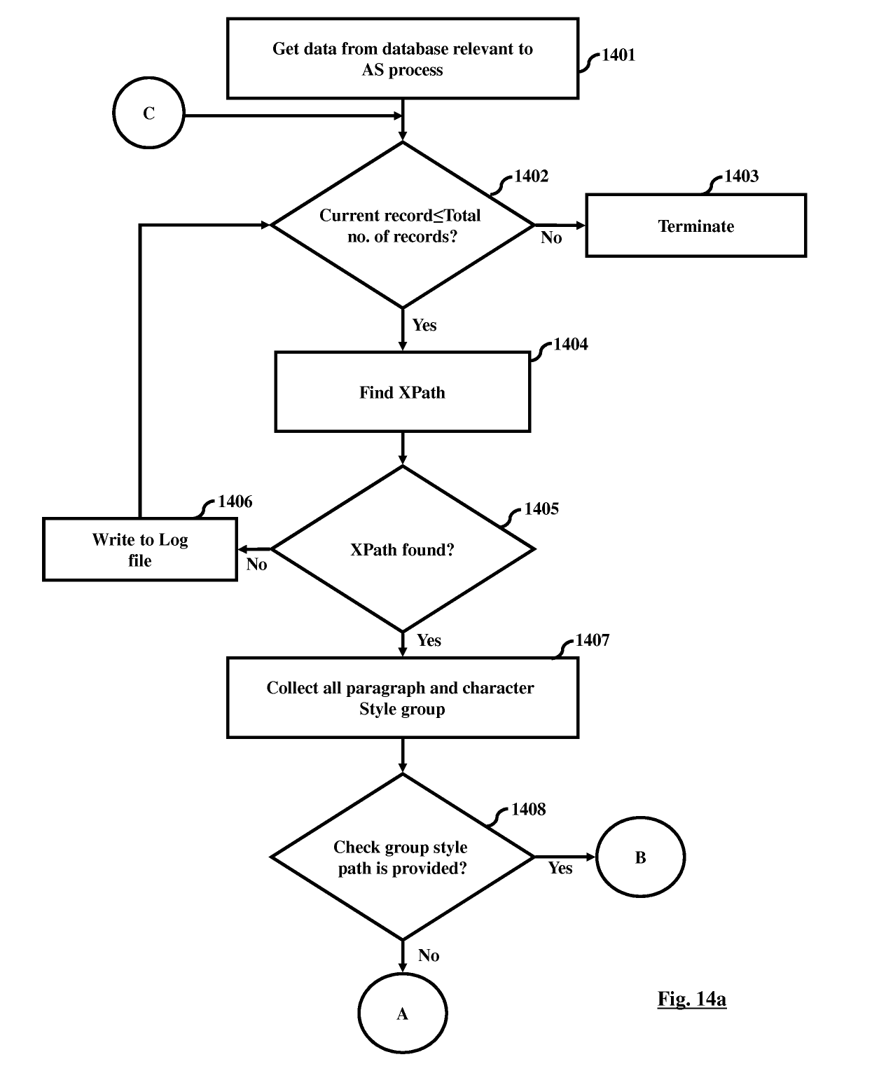

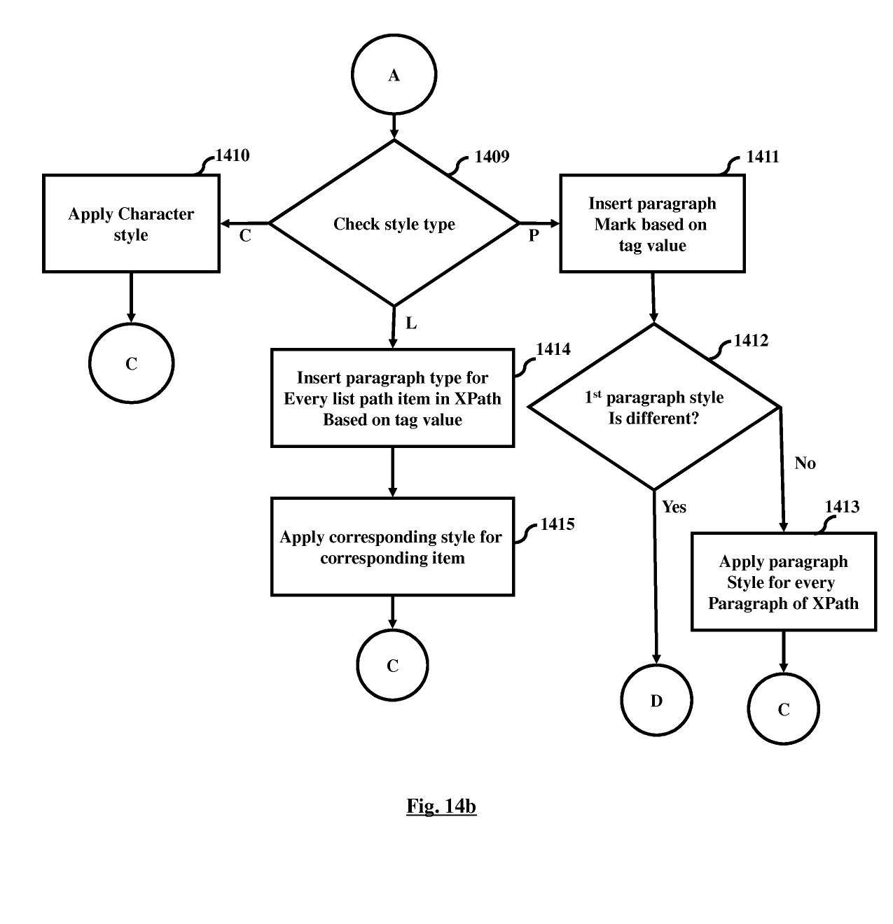

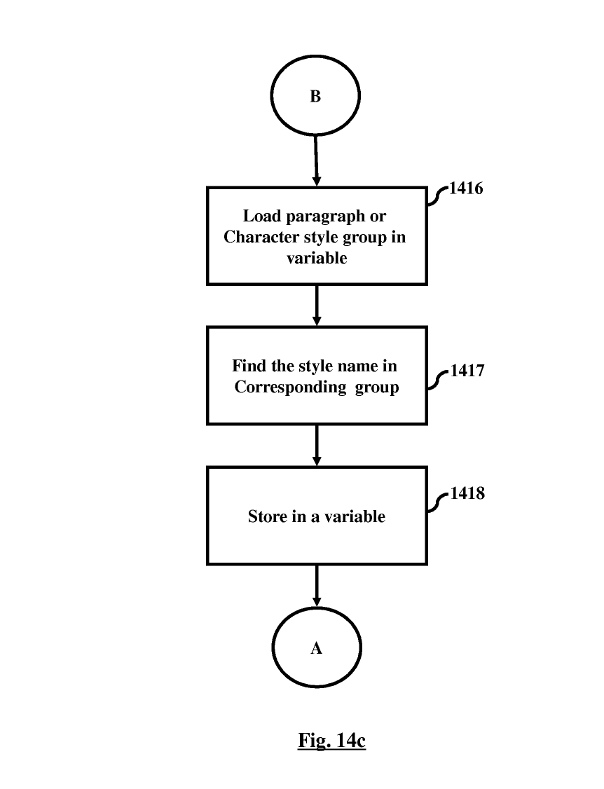

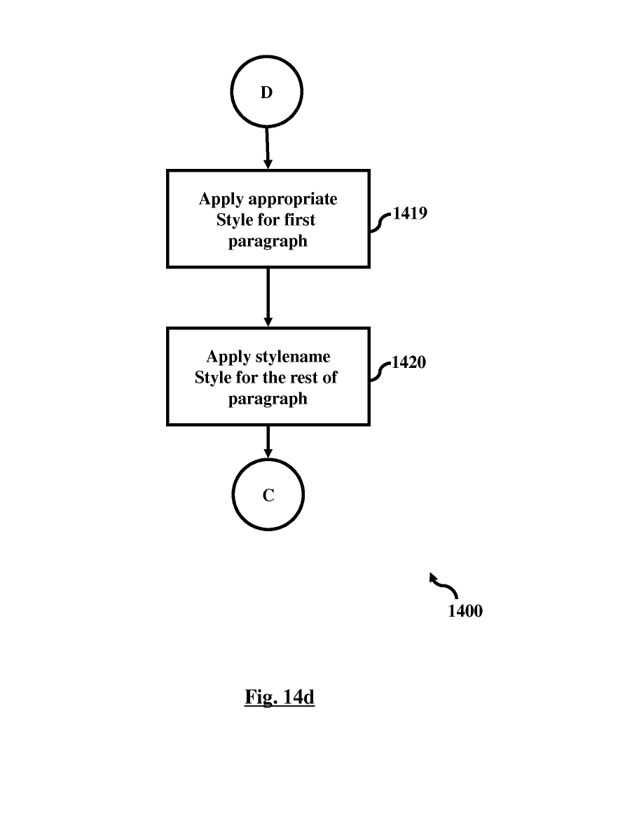

FIGS. 14a-14d are flow diagrams, which show the process of Applying Styles (AS) as disclosed in the embodiments herein. InXML automates process of application of styles for paragraph, character, list, group and table items. In an embodiment, different styles can be applied for same XML element with different XPaths or for same elements with same XPaths but possessing different attributes. In another embodiment, different styles can be applied for items first, middle or last in the list. In another embodiment, table styles can be applied for all tables in document based on XPath.

The application initially fetches data from database. In an embodiment, the application fetches (1401) data of a specific type. In another embodiment, the data is of type “AS”. Then the application checks (1402) if the current record is less than or equal to total number of records. If the current record is not less than or equal to total number of records, then the AS process is terminated (1403). If the current record is less than the total number of records, then the application tries to find out (1404) XPath and checks (1405), if the XPath exists or not. If XPath does not exist, then corresponding entry is made (1406) in Log file and proceed with the next record (1402). If XPath is found, all paragraph and character style groups are selected (1407) and the application checks (1408) if group style path is provided or not. If group style path is not provided, then the application checks (1409) the style type. If style type is “C”, character style is applied (1410) and the application tries to find the next XPath (1404). If style type is “L”, paragraph type is inserted (1414) for every list path item in XPath. In an embodiment, the paragraph type is listed in XPath based on tag value. Then styles corresponding to each item is applied (1415) and the application tries to find the next XPath (1404). If the style type is “P”, then the application insert (1411) paragraph mark based on tag value. Then the application checks (1412) if the first paragraph style is different or not. If the paragraph style is not different, then paragraph style is applied (1413) for every paragraph of XPath and the application tries to find out the next XPath (1404). If in 1412, 1^{st} paragraph style is different, appropriate style is applied (1419) for the first paragraph and style name and style is applied (1420) for the rest of paragraph. Then the application tries to find out (1404) the next XPath.

If group style path is provided in 1408, the application initially load (1416) paragraph or character style group in variable. Then the application find out (1417) style name in corresponding groups and store (1418) the obtained style name in a variable. The various actions in method 1400 may be performed in the order presented, in a different order or simultaneously. Further, in some embodiments, some actions listed in FIGS. 14a-14d may be omitted.

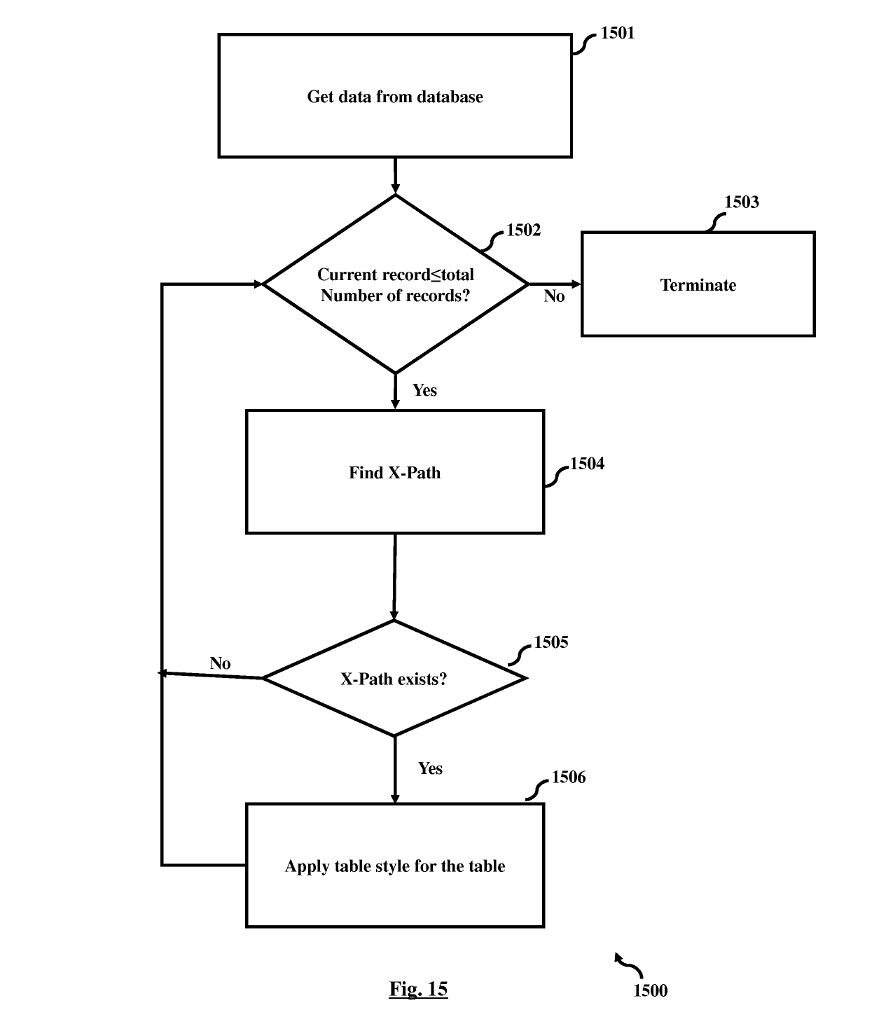

FIG. 15 is a flow diagram which shows the process of Applying Table Styles (ATS) as disclosed in the embodiments herein. The application initially fetches (1501) data from a database. In an embodiment, the application fetch data from the database of type “SIE” and style type “T”. Then the application checks (1502) if the current record is less than or equal to total number of records. If the current record is not less than or equal to total number of records, then the ATS process is terminated (1503).

If the current record is less than the total number of records, then the application tries to find out (1504) XPath and checks (1505), if the XPath exists or not. If XPath does not exist, proceed with the next record (1502). If XPath is found, applies (1506) table style for the tables. Further, the process is repeated with next record. The various actions in method 1500 may be performed in the order presented, in a different order or simultaneously. Further, in some embodiments, some actions listed in FIG. 15 may be omitted.

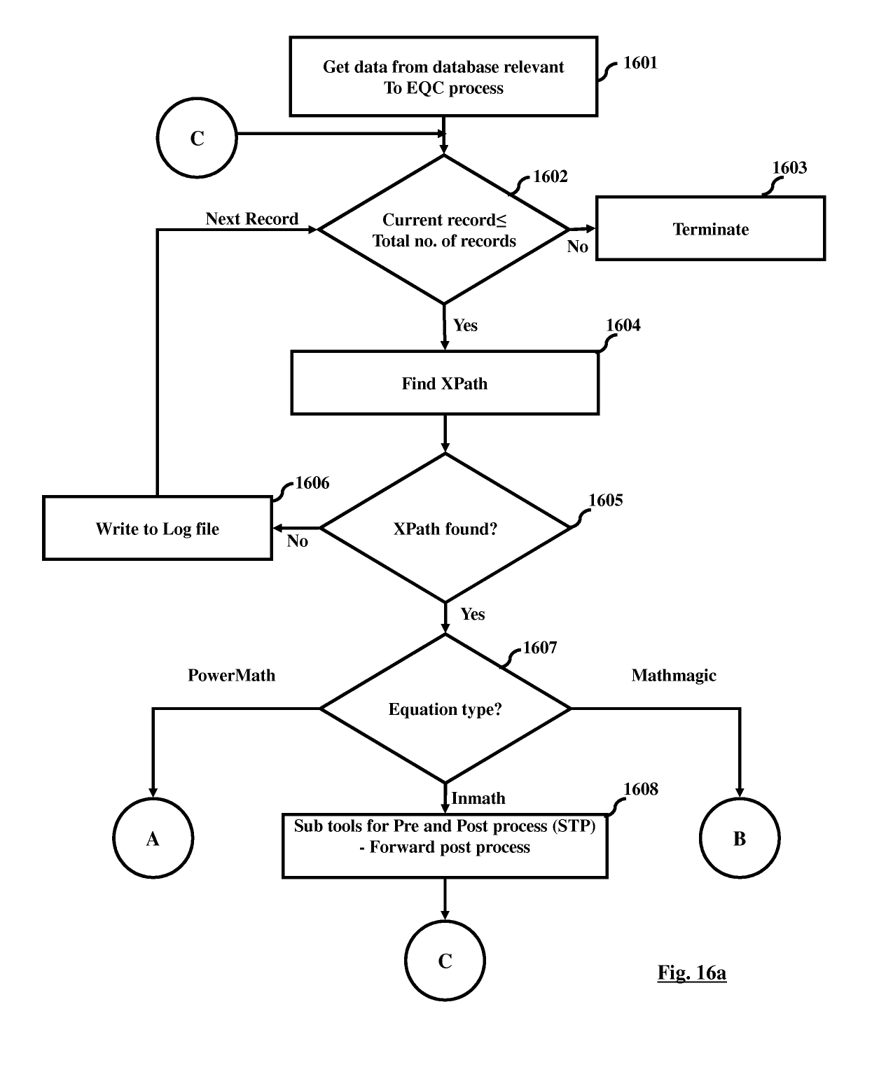

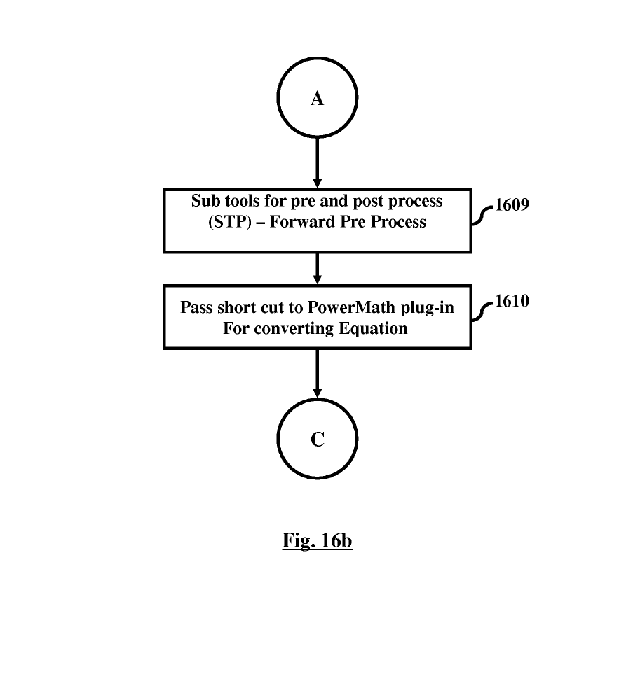

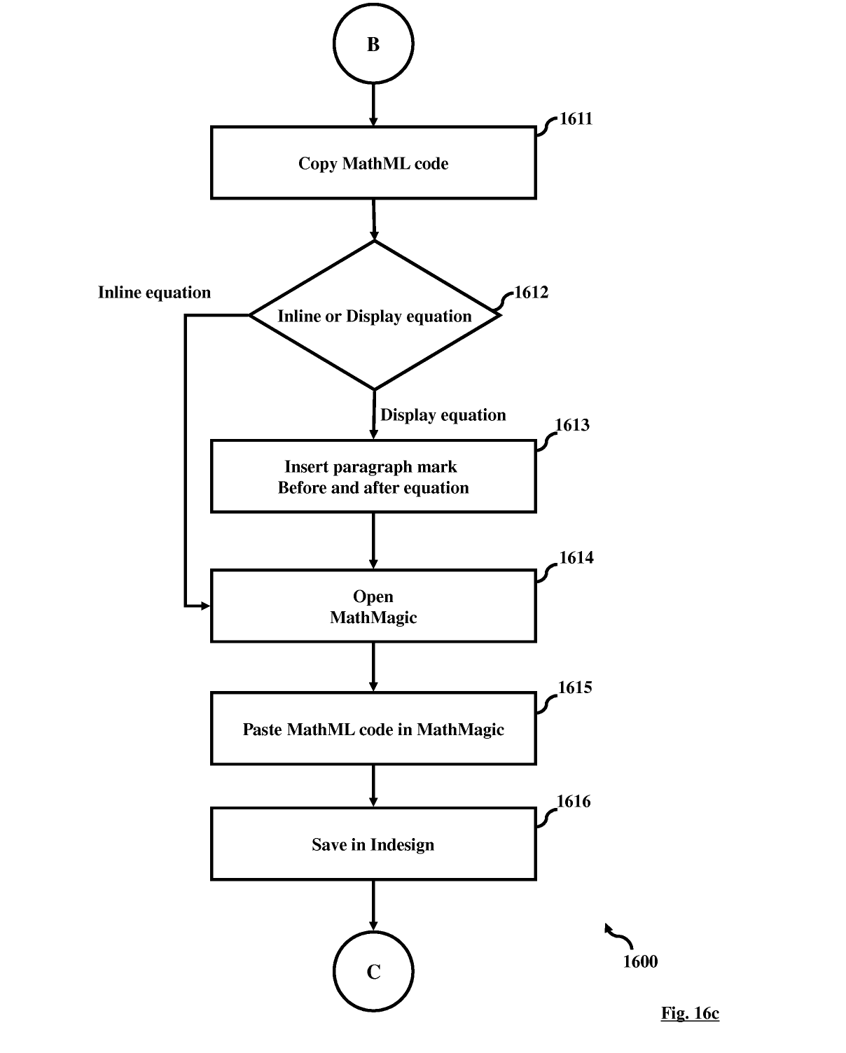

FIGS. 16a-16c are flow diagrams which show the Equation Conversion Process (ECP) as disclosed in the embodiments herein. InXML is capable of converting MathML (Mathematical Markup Language) equation in XML input file to be compatible with PowerMath, InMath or MathMagic based on requirement.

The application initially fetches data related to Equation Conversion Process (EQC) from the database and checks (1602) if current record is lesser than or equal to total number of records. If current record is not lesser than or equal to total number of records, EQC process is terminated (1603). If the current record is less than or equal to the total number of records, then the application tries to find out (1604) XPath and checks (1605) after a particular time period, if the XPath exists or not. If XPath does not exist, then corresponding entry is made (1606) in Log file and proceed with the next record (1602). If XPath is found, then the equation type is considered (1607). If equation is of InMath type, sub tools are executed (1608) on the XML file and the application try to find out (1604) the next XPath. In an embodiment, sub tools for pre and post process can be executable, scripts and/or XSLT. In another embodiment, an InMath equation can be converted to MathML equation using a script. In another embodiment, the script used for converting InMath equation to MathML equation can be a java script. If the equation is of PowerMath type, subtools are executed (1609) on the XML file. In an embodiment, sub tools for pre and post process can be executable, scripts and/or XSLT. Further, short-cuts are passed (1610) to PowerMath plugIn for the purpose of conversion of equation and the application try to find out (1604) next XPath. In an embodiment, PowerMath Plug in is used for code associated with mathematical expressions/equations to be expressed with correct mathematical notations. If the equation is of MathMagic type, the application initially copies the MathML code. Then the application checks if the equation is of Inline or Display type. If the equation is of Display type, paragraph mark is inserted (1613) before and after the equation and then open the MathMagic (1614). Further, the application pastes (1615) MathML code to MathMagic and the saved in InDesign (1616). Once the InDesign is saved, the application tries to find out the next XPath. The various actions in method 1600 may be performed in the order presented, in a different order or simultaneously. Further, in some embodiments, some actions listed in FIGS. 16a-16c may be omitted.

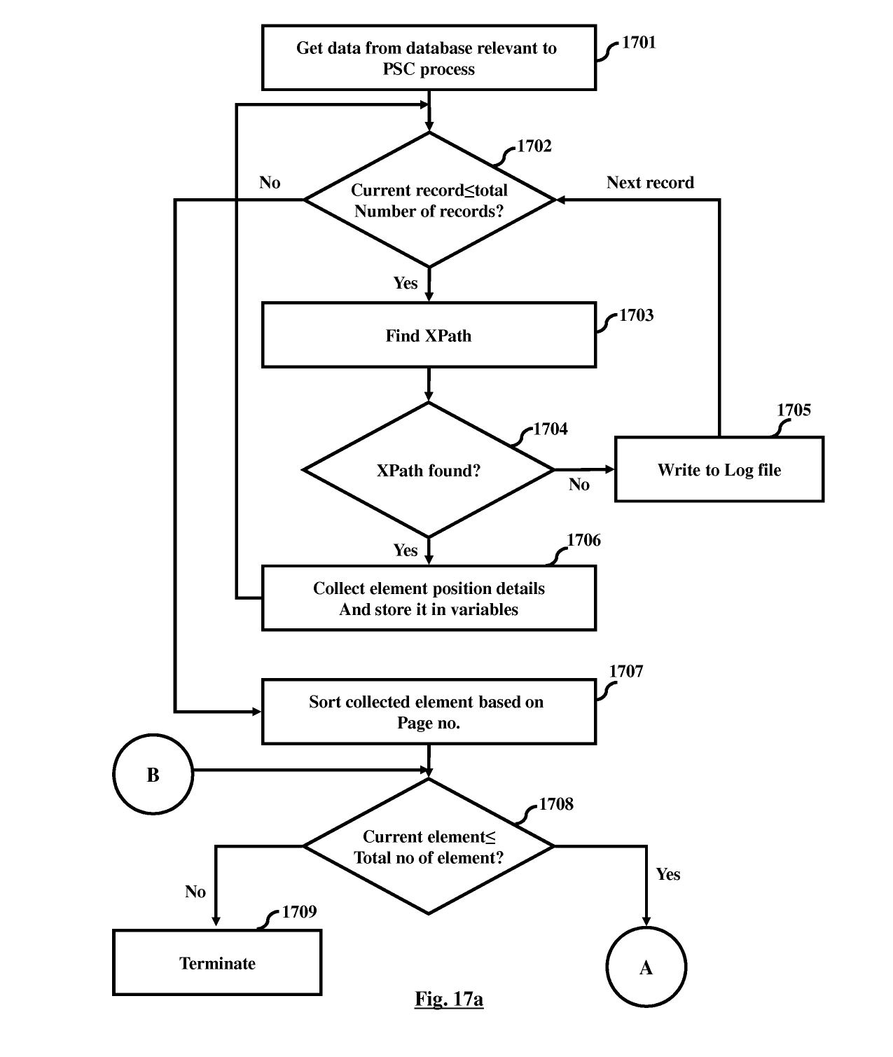

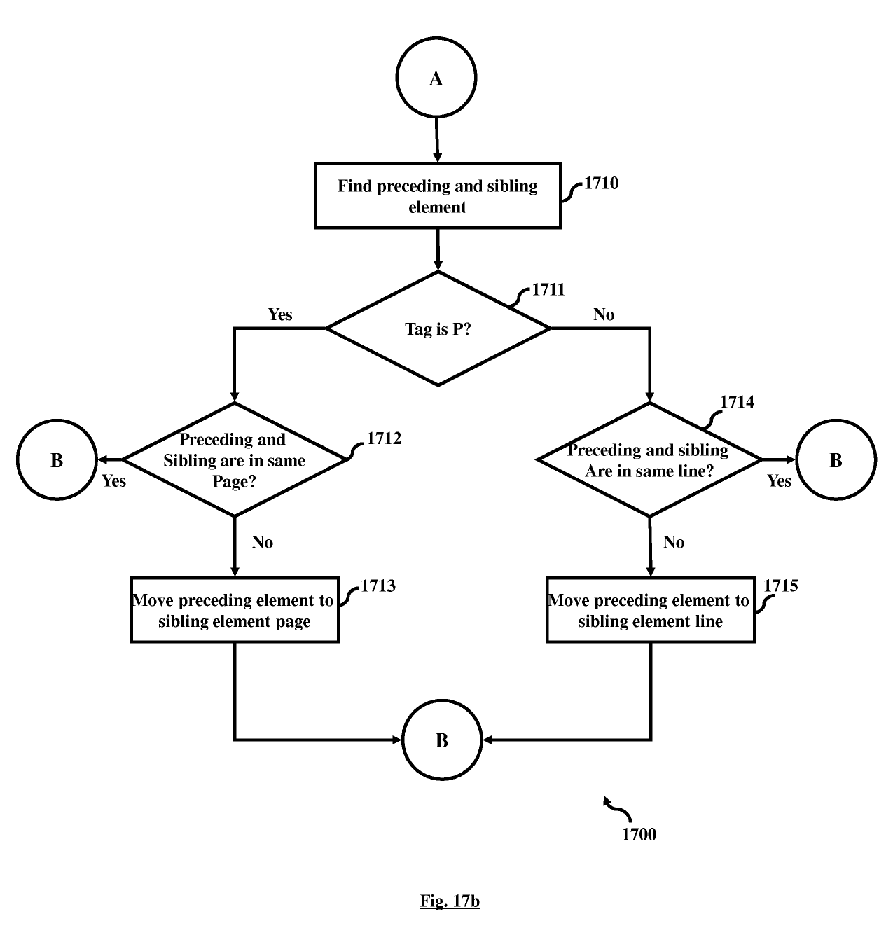

FIGS. 17a-17b are flow diagrams, which show the process of Preceding Sibling Checking (PSC) as disclosed in the embodiments herein. In certain conditions, it is needed that an XML element and corresponding sibling and/or preceding elements are in same page or same line. PSC checks if the elements and corresponding siblings and/or preceding elements are in same page/line and also forces movements of XML elements to be in same line/page.

The application initially fetches (1701) a related to PSC from the database and checks (1702) if current record is lesser than or equal to total number of records. If the current record is less than or equal to the total number of records, then the application tries to find out (1703) XPath and checks (1704) after a particular time period, if the XPath exists or not. If XPath does not exist, corresponding entry is made (1705) in the Log file and the application proceed with the next record. If XPath is found, element position details are collected (1706) and are stored in variables. If current record is not less than or equal to total number of records, the application sort (1707) collected elements. In an embodiment, the collected elements are sorted based on page numbers. After sorting the collected elements, the application checks (1708) if the current element is less than or equal to total number of elements. If the current record is not less than the total number of records, PSC process is terminated (1709). If the current element is less than or equal to total number of elements, application find out (1710) preceding and sibling elements for that particular element. Then the application checks (1711) if tag associated with that particular element is “P”. If tag is “P”, then the application checks (1712) if the preceding and sibling elements are in same page. If preceding and sibling are in same page, then application checks for the next element (1708). If preceding and sibling elements are not in same page, then the application moves the preceding element to the sibling element page and the application checks for the (1708) for the next element. If tag is not “P” in 1711, the application checks if the preceding and sibling elements are in same line. If preceding and sibling elements are in same line, the application check for the next element (1708). If the preceding and sibling elements are not in the same line, the application moves the preceding element to sibling element line and check for the next element and repeat PSC. The various actions in method 1700 may be performed in the order presented, in a different order or simultaneously. Further, in some embodiments, some actions listed in FIGS. 17a-17b may be omitted.

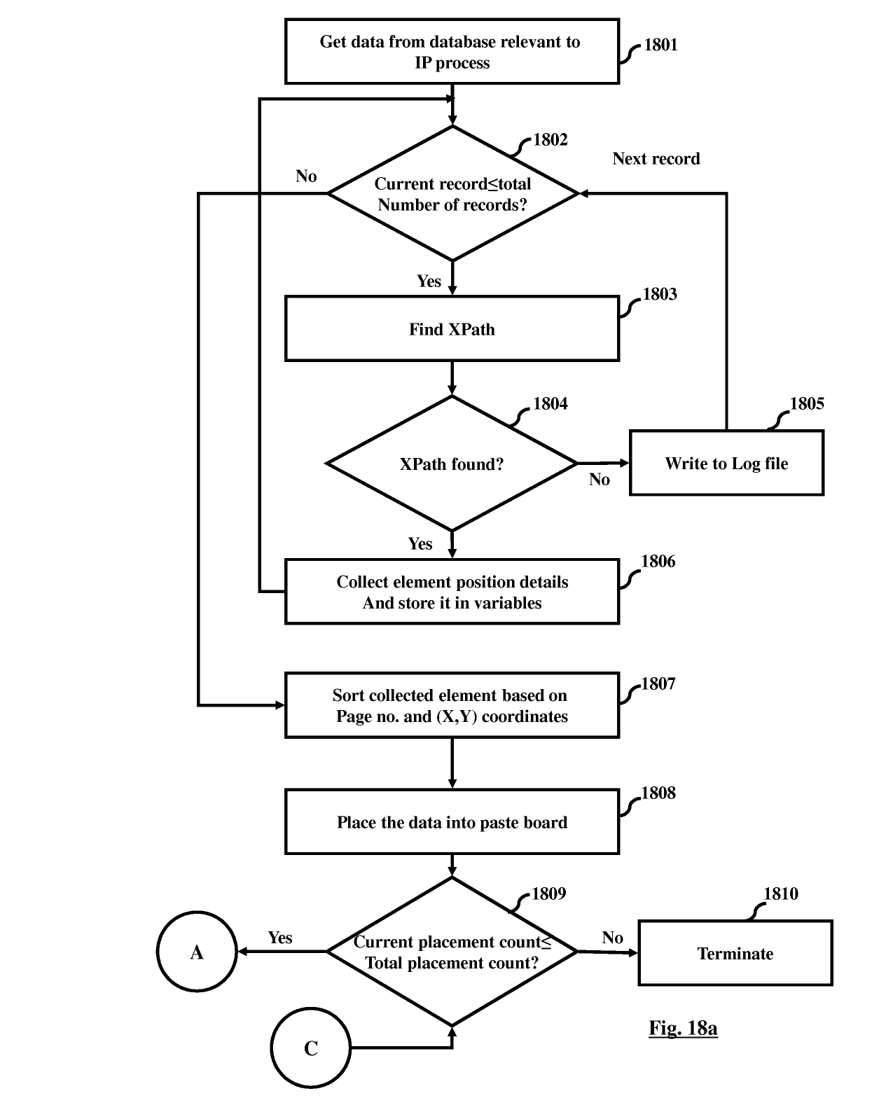

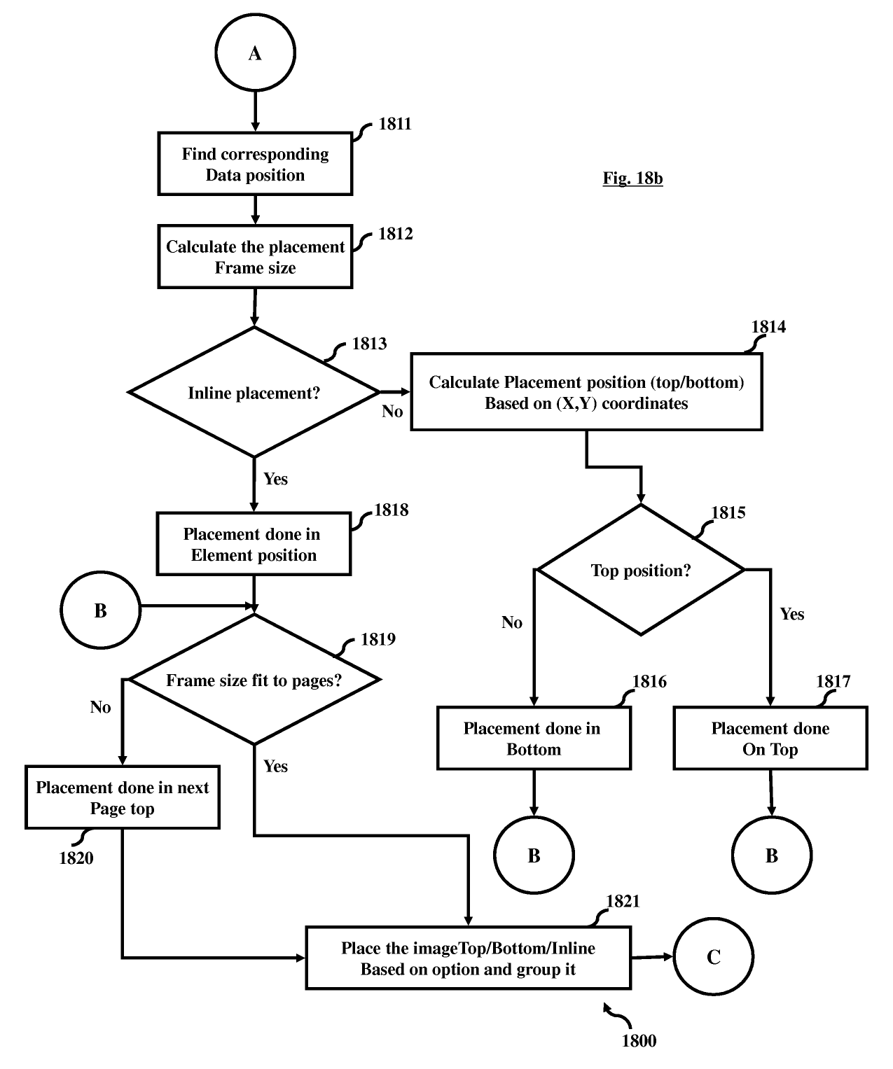

FIGS. 18a-18b are flow diagrams, which show the process of Inside Placement (IP) as disclosed in the embodiments herein. Inside Placement is done for floating placements of figures, tables and library items. In an embodiment, an item can be placed inline or top/bottom. Inline placement places element beside related content. Fitment to page is considered while doing top/bottom placement. In another embodiment, placement can be moved to another page to avoid overlapping. In another embodiment, any specified element can be placed individually in required text frame in case of library items.

The application initially fetches (1801) data related to Inside Placement from the database and checks (1802) if the current record is less than or equal to total number of records. If the current record is less than or equal to the total number of records, then the application tries to find out (1803) XPath and checks (1804) after a particular time period, if the XPath exists or not. If XPath does not exist, corresponding entry is made (1805) in the Log file and the application proceed with the next record. If XPath is found, the application collects element position details and stores (1806) the collected element position details in variables. If the current record is less than or equal to total number of records, the collected elements are sorted (1807) based on page number and (X,Y) coordinates. The data is then placed (1808) into a paste board and the application checks (1809) if current placement count is less than or equal to total placement count. If current placement count is not less than or equal to total placement count, IP process is terminated (1810). If current placement count is less than or equal to total placement count, corresponding data position is found out (1811) and placement frame size for that particular element is calculated (1812).

Based on the calculated placement count, the application checks (1813) if Inside Placement has taken place or not. If Inline placement is done, the application place (1818) the element in element position and checks (1819) if frame size is fit to the pages. If frame size is not fit to the page, placement is done (1820) on the top of next page. If frame size is fit to pages, image is placed on the top/bottom/inline based on option and the elements are grouped (1821). Then the control goes to 1809.

If in 1813, inline placement is not detected, placement position is calculated based on (X,Y) coordinates. Then the application checks (1815) if the placement position is on the top. If placement position is on the top, element is placed on the top of the page (1817) and if element placement position is in bottom, element is placed (1816) in bottom of page. Once the element is placed in appropriate position, control goes to 1819 where the application checks if the frame size fit to the pages. The various actions in method 1800 may be performed in the order presented, in a different order or simultaneously. Further, in some embodiments, some actions listed in FIGS. 18a-18b may be omitted.

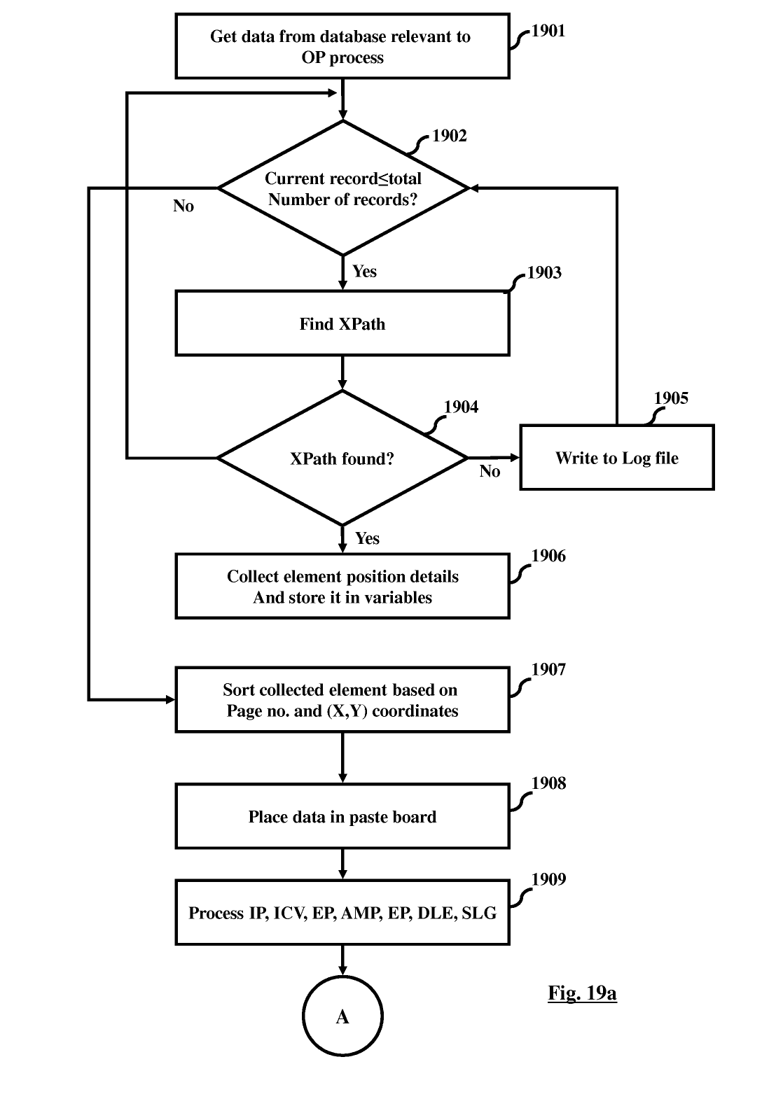

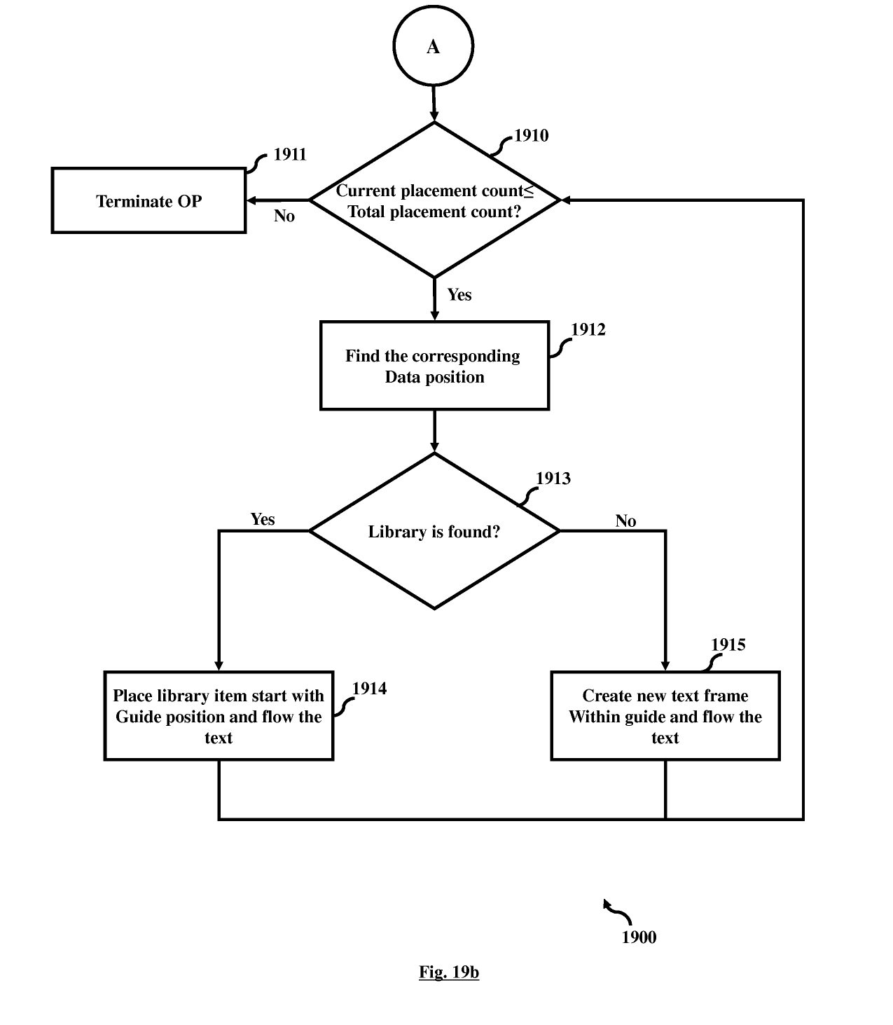

FIGS. 19a-19b are flow diagrams, which show the process of Outside Placement (OP) as disclosed in the embodiments herein. Outside placement is done for automatic floating placement of side notes and marginal notes. In an embodiment, side notes or margin notes are placed by guides or text frames or margins. In another embodiment, placement is done contextually.

The application initially fetches (1901) data related to Inside Placement from the database and checks (1902) if the current record is less than or equal to total number of records. If the current record is less than or equal to the total number of records, then the application tries to find out (1903) XPath and checks (1904) after a particular time period, if the XPath exists or not. If XPath does not exist, corresponding entry is made (1905) in the Log file and the application proceed with the next record. If XPath is found, element position details are collected (1906) and are stored in variables. Then the control goes to 1903. If current record is not less than or equal to total number of records, collected elements are sorted (1907) based on page number and (X, Y) coordinates. The data is then placed in a paste board (1908) and is processed using processes such as Inside Placement (IP), Insertion of XML content or variable (ICV), Master Page and Library item data (MLD), Applying Master Page (AMP), Different Layers (DLE) and Slug Frames (SLG). Then the application checks (1910) if current placement count is less than or equal to total placement count. If current placement count is not less than or equal to total placement count, the OP process is terminated (1911). If current placement count is less than or equal to total placement count, the application find out (1912) corresponding data position. Then the application checks (1913) if library is found. If library is found, guide position is placed (1914) in the library item start and the text is allowed to flow. If library is not found, new text frame is created (1915) within guide and text is allowed to flow. Then the application repeats the procedure for the consecutive placement counts. The various actions in method 1900 may be performed in the order presented, in a different order or simultaneously. Further, in some embodiments, some actions listed in FIGS. 19a-19b may be omitted.

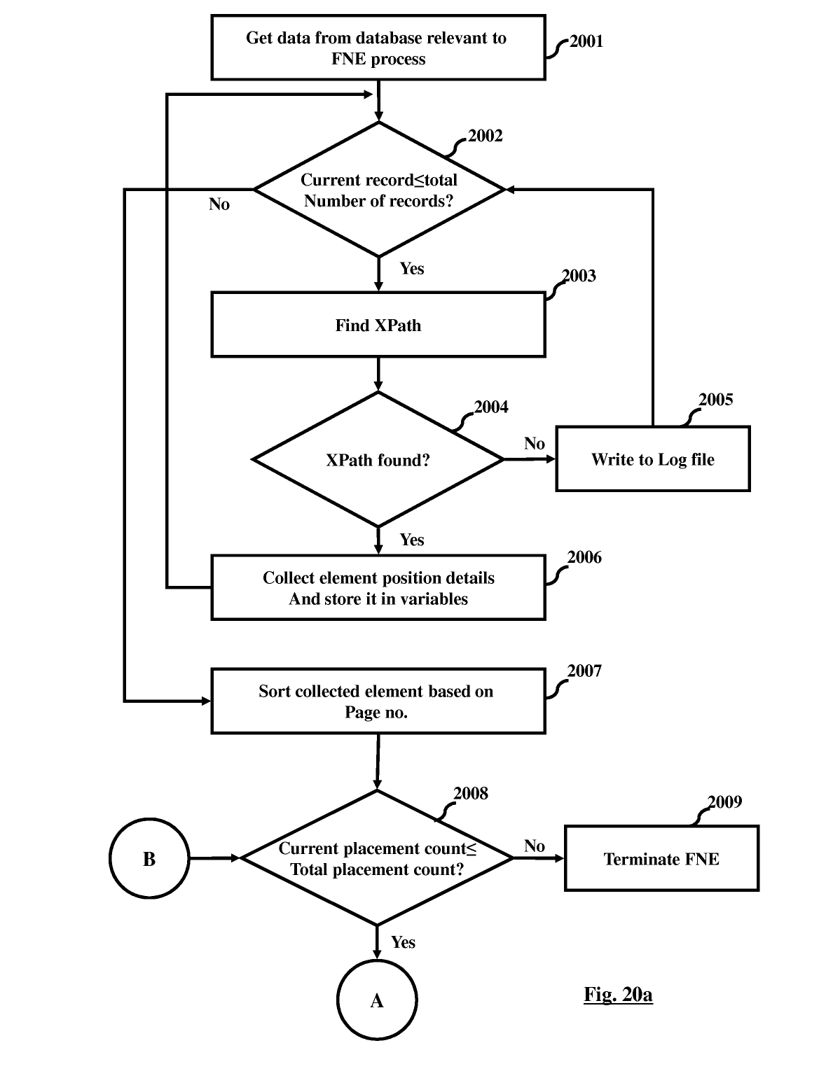

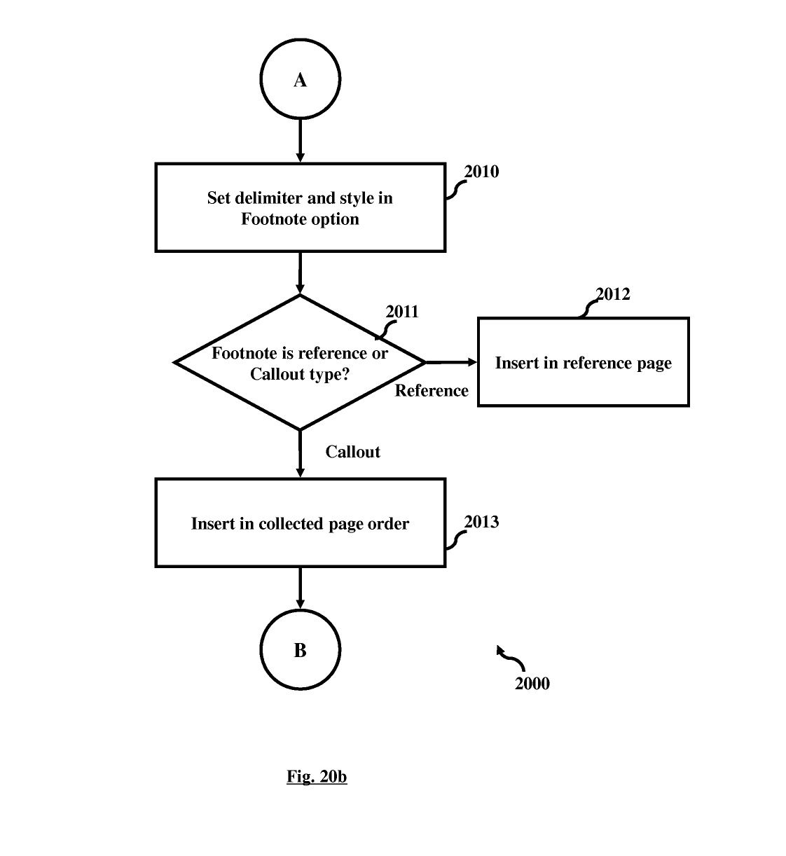

FIGS. 20a-20b are flow diagrams, which show the process of inserting Foot Notes (FNE) as disclosed in the embodiments herein. InXML supports automatic insertion and layout of footnotes in the document. A footnote entered with an id attribute is a use-by-reference footnote. This Footnote is inserted by Reference Page Number. A footnote with no given id attribute is a single-use footnote. Upon output, it generates a number as a superscript “callout” that is linked to the placement of the footnote. This Footnote is inserted in collected Page Order.

The application initially fetches (2001) data related to Inside Placement from the database and checks (2002) if the current record is less than or equal to total number of records. If the current record is less than or equal to the total number of records, then the application tries to find out (2003) XPath and checks (2004), if the XPath exists or not. If XPath does not exist, corresponding entry is made (2005) in the Log file and the application proceed with the next record. If XPath is found, element position details are collected (2006) and are stored in variables. Then the control goes to 2003. If current record is not less than or equal to total number of records, collected elements are sorted (2007) based on page number. Then the application checks (2008) if current placement count is less than or equal to total placement count. If current placement count is not less than or equal to total placement count, FNE is terminated (2009). If current placement count is less than or equal to total placement count, the application sets (2010) delimiter and style in footnote option. Then the application checks (2011) if footnote is of reference or callout type. If footnote is of reference type, that footnote is inserted (2012) in the reference page. If footnote is of callout type, that footnote is inserted (2013) in collected page order and the processes are repeated for succeeding foot notes. The various actions in method 2000 may be performed in the order presented, in a different order or simultaneously. Further, in some embodiments, some actions listed in FIGS. 20a-20b may be omitted.

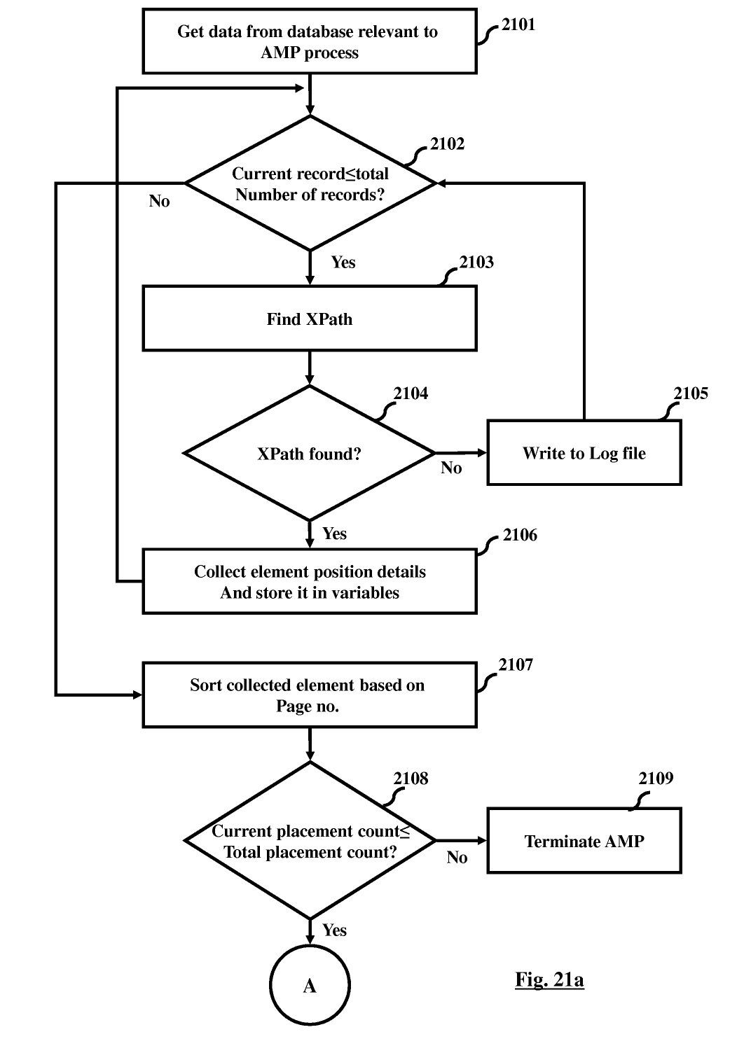

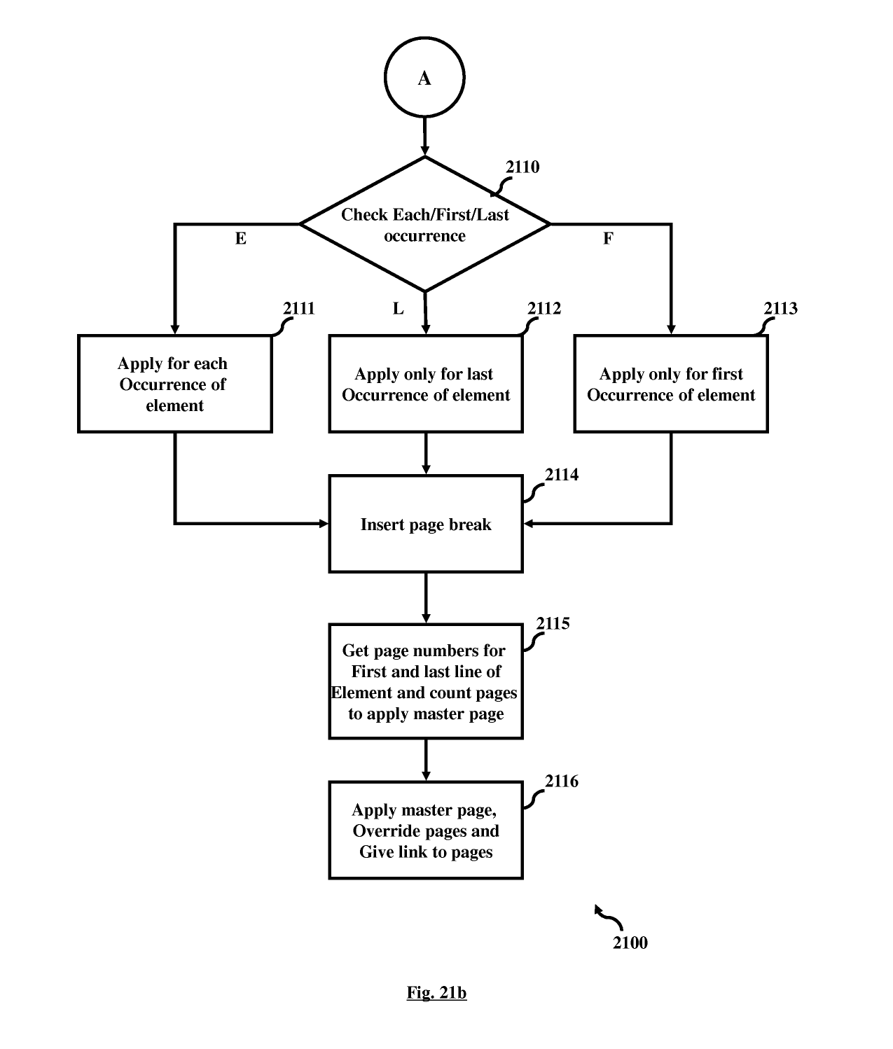

FIGS. 21a-21b are flow diagrams, which show the process of Applying Master Page (AMP) as disclosed in the embodiments herein. Master page is used to achieve consistency in page design. In an embodiment, basic layout can be set in a master page. In another embodiment, all pages added to a document based on master page will have same appearance. Process of applying master pages in InXML allows use of multiple master pages in same document.

The application initially fetches (2101) data related to Inside Placement from the database and checks (2102) if the current record is less than or equal to total number of records. If the current record is less than or equal to the total number of records, then the application tries to find out (2103) XPath and checks (2104) after a particular time period, if the XPath exists or not. If XPath does not exist, corresponding entry is made (2105) in the Log file and the application proceeds with the next record. If XPath is found, element position details are collected (2106) and are stored in variables. Then the control goes to 2103. If current record is not less than or equal to total number of records, collected elements are sorted (2107) based on page number. Then the application checks (2108) if current placement count is less than or equal to total placement count. If current placement count is not less than or equal to total placement count, FNE is terminated (2109). If current placement count is less than or equal to total placement count, the application checks (2110) for which type of appearance, master page is to be applied. Based upon user preference, the application applies master pages for each occurrence of element (2111) or only for last occurrence of element (2112) or else, only for the first occurrence (2113) of element. Then, page break is applied (2114) in the pages. Further, in order to apply master page, number of pages is being count (2115) by obtaining page number for first and last line of element. Then the master page is applied to the document. In an embodiment, links are given in the master page, which leads to other pages. The various actions in method 2100 may be performed in the order presented, in a different order or simultaneously. Further, in some embodiments, some actions listed in FIGS. 21a-21b may be omitted.

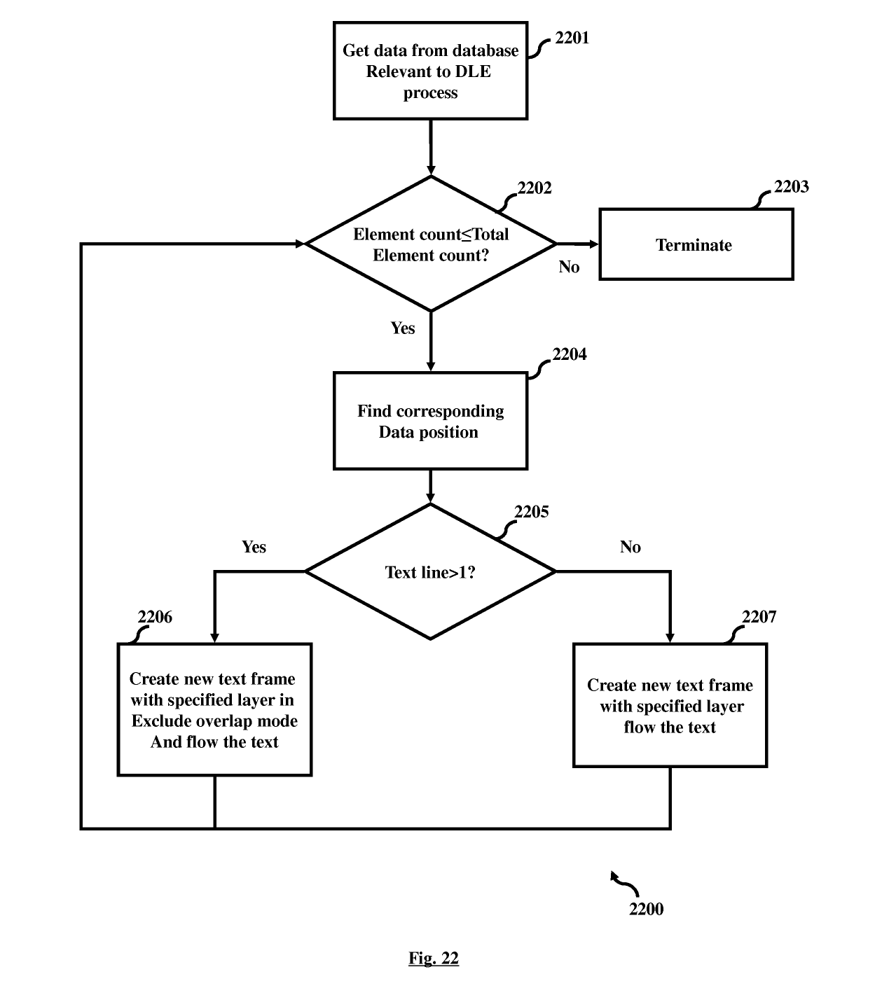

FIG. 22 is a flow diagram, which shows the process of placing element contents in Different Layers (DLE) as disclosed in the embodiments herein. Alternate design ideas for same layout can be displayed using layers. DLE automates process of placement of elements in different layers.

The application fetches (2201) data related to “DLE” from the database. Then the application checks (2202) if element count is less than or equal to total element count. If element count is not less than or equal to total element count, DLE process is terminated (2203). If element count is less than or equal to total element count the application finds (2204) data position corresponding to that particular element. Then the application checks (2205) if text line is greater than 1. If text line is greater than 1, a new text frame is created (2206) with exclude overlap mode and the text is allowed to flow to the newly created frame. If text frame is not greater than 1, a new text frame is created (2207) with specified layer and the text is allowed to flow to the newly created text frame. The process is continued for following elements. The various actions in method 2200 may be performed in the order presented, in a different order or simultaneously. Further, in some embodiments, some actions listed in FIG. 22 may be omitted.

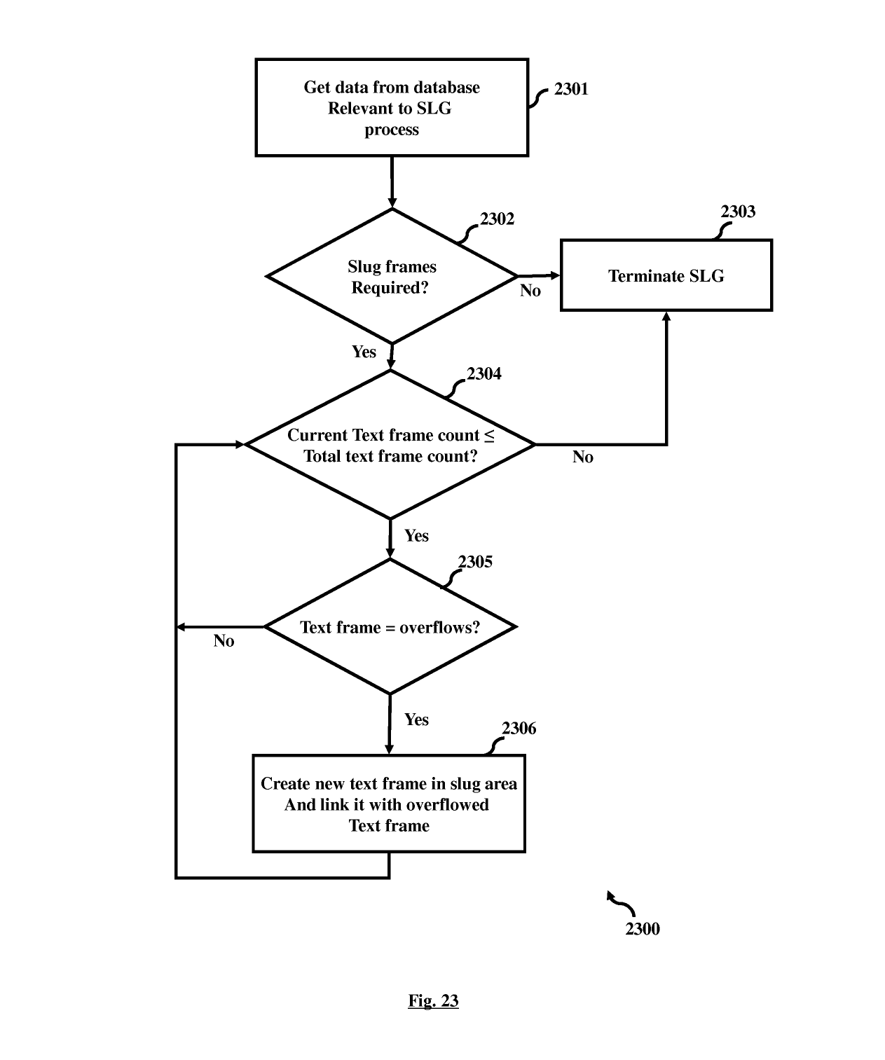

FIG. 23 is a flow diagram, which shows the process of moving overflowed text to slug area (SLG) as disclosed in the embodiments herein. A slug area is used for storing information related to a document that is discarded when a document is trimmed to its final page size. Further, in text overflow conditions in a text frame, a link is created to another new text frame created in slug area.

The application fetch (2301) data related to SLG process from the database. The application initially checks (2302) if slug frames are required for the text frame under consideration. If slug frames are not required, SLG process is terminated (2303). If slug frames are required, then the application checks (2304) if current text frame count is less than or equal to total text frame count. If current text frame count is not less than or equal to total text frame count, SLG process is terminated (2303). If current text frame count is less than or equal to total text frame count, then the application checks (2305) if overflow is occurring in the text frame. If an overflow is not occurring in that text frame, the application checks in the next text frame. If an overflow condition is detected, the application creates (2306) a new text frame in slug area and link the newly created text frame with the overflowed text frame. This process is repeated for all text frames. The various actions in method 2300 may be performed in the order presented, in a different order or simultaneously. Further, in some embodiments, some actions listed in FIG. 23 may be omitted.

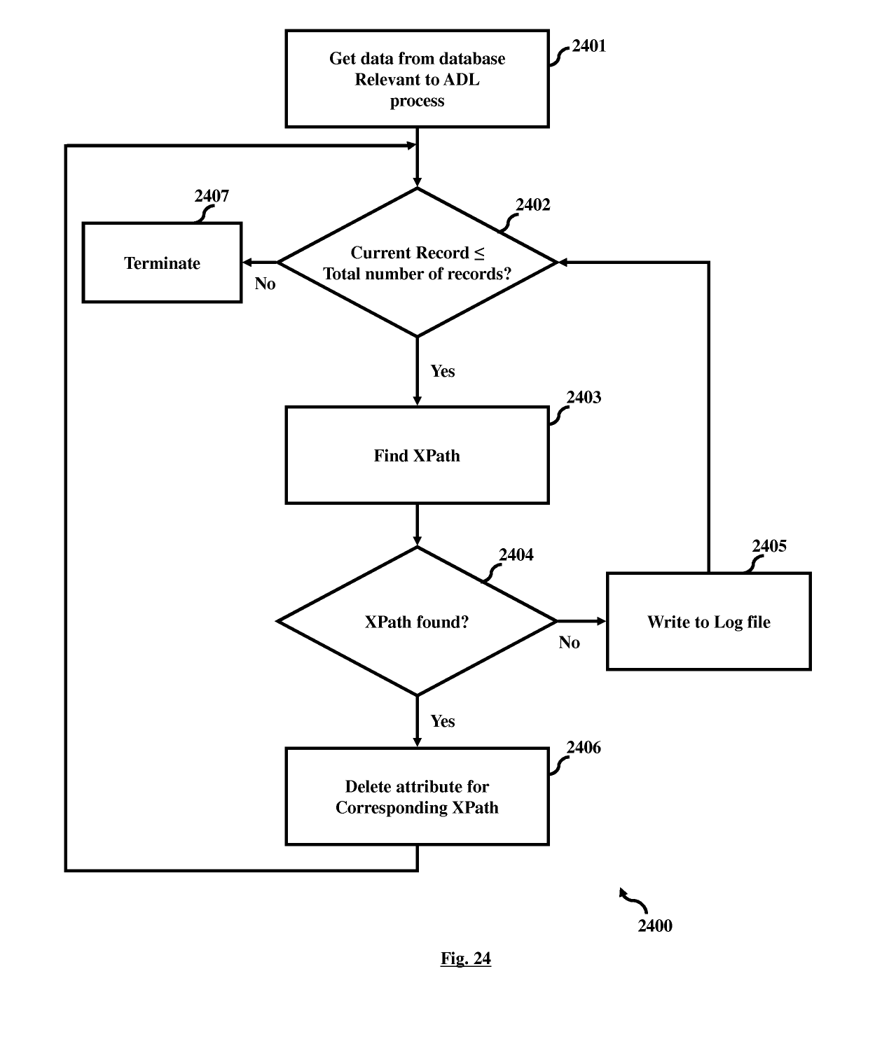

FIG. 24 is a flow diagram, which shows the process of Attribute Deletion (ADL) as disclosed in the embodiments herein. ADL is used for the purpose of deletion of unwanted attributes in an InDesign document.

The application fetch (2401) data related to ADL process from the database. Then the application checks (2402) if current record is less than or equal to total number of records. If current record is not less than or equal to total number of records, ADL process is terminated (2407). If the current record is less than or equal to the total number of records, then the application tries to find out (2403) XPath and checks (2404) after a particular time period, if the XPath exists or not. If XPath does not exist, corresponding entry is made (2405) in the Log file and the application proceed with the next record. If XPath is found, attributes corresponding to that XPath are deleted (2406). Then the application checks for (2403) next XPath and repeat ADL process. The various actions in method 2400 may be performed in the order presented, in a different order or simultaneously. Further, in some embodiments, some actions listed in FIG. 24 may be omitted.

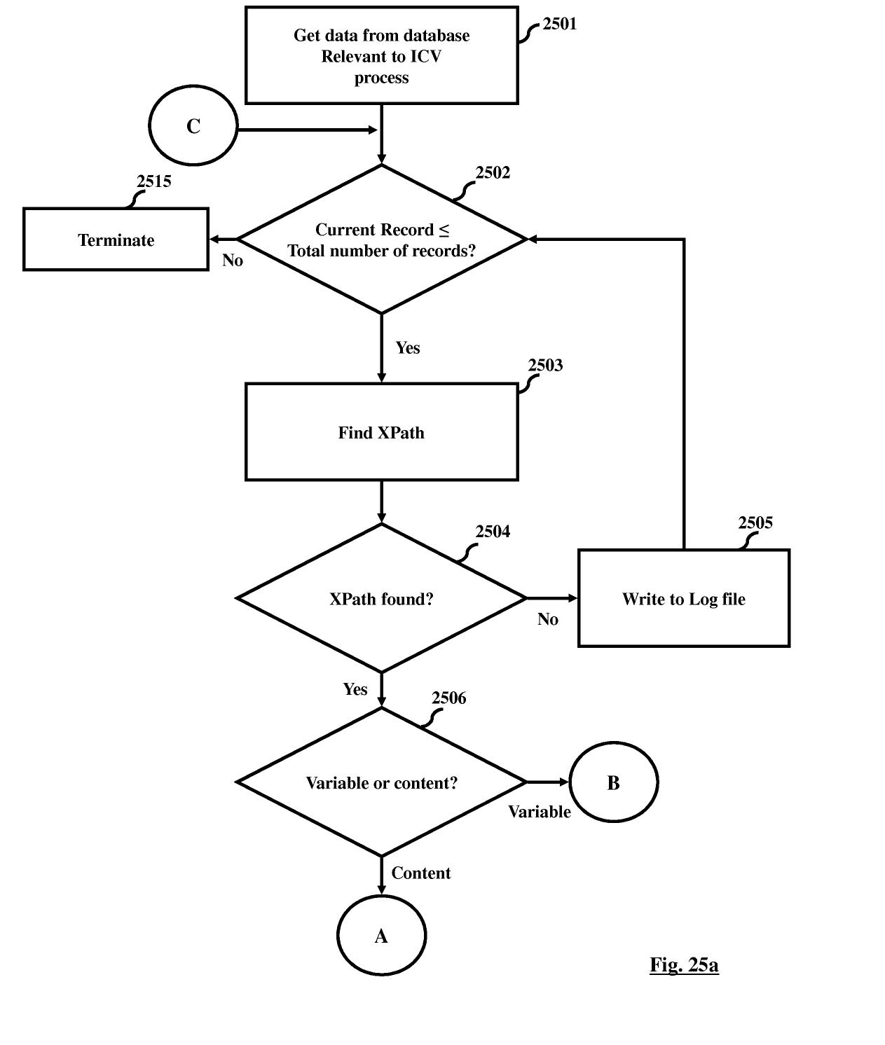

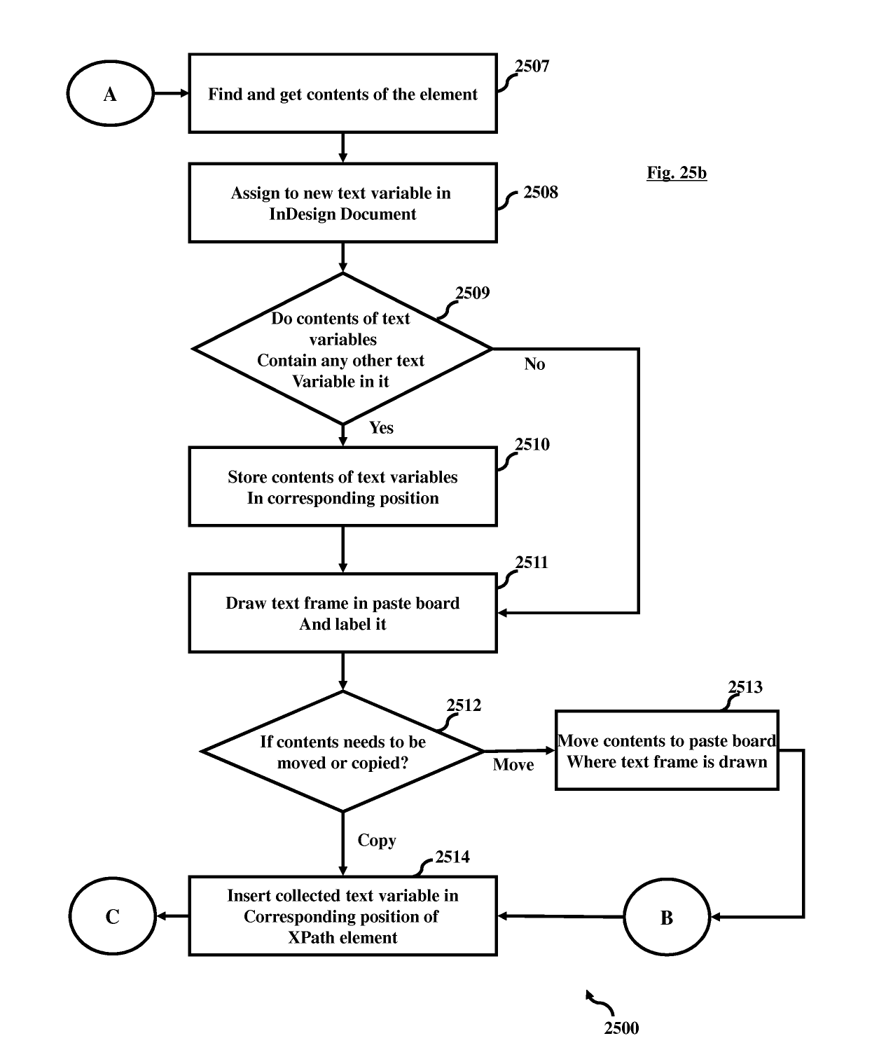

FIGS. 25a-25b are flow diagrams, which show the process of Insertion of XML elements or contents, or variable (ICV) as disclosed in the embodiments herein. ICV is used for automating process of insertion of XML contents or variable in InDesign documents.

The application initially fetches (2501) data related to Inside Placement from the database and checks (2502) if the current record is less than or equal to total number of records. If the current record is not less than or equal to the total number of records, ICV process is terminated (2515). If the current record is less than or equal to the total number of records, then the application tries to find out (2503) XPath and checks (2504) after a particular time period, if the XPath exists or not. If XPath does not exist, corresponding entry is made (2505) in the Log file and the application proceed with the next record. If XPath is found, the application check (2506) if the found XPath is a variable or content. If content is selected, the application find and get (2507) contents of. The contents are then assigned (2508) to new text variables in InDesign document. The application then checks (2509) if contents of text variables contain any other text variables in that text variable. If contents of text variables contain any other text variables, contents of text variables are then stored (2510) in corresponding positions. A text frame is then drawn in pasteboard and is labeled (2511). If contents of text variables contain no other text variables, step 2511 is executed. Then the application checks (2512) if contents are to be moved or copied. If “move” option is selected, contents are moved (2513) to a pasteboard where text frame is drawn. Then the application insert (2514) collected text variables in corresponding positions of XPath element. If in 2506, variable is selected, step 2514 is executed directly. ICV is then repeated for other XPath elements. The various actions in method 2500 may be performed in the order presented, in a different order or simultaneously. Further, in some embodiments, some actions listed in FIGS. 25a-25b may be omitted.

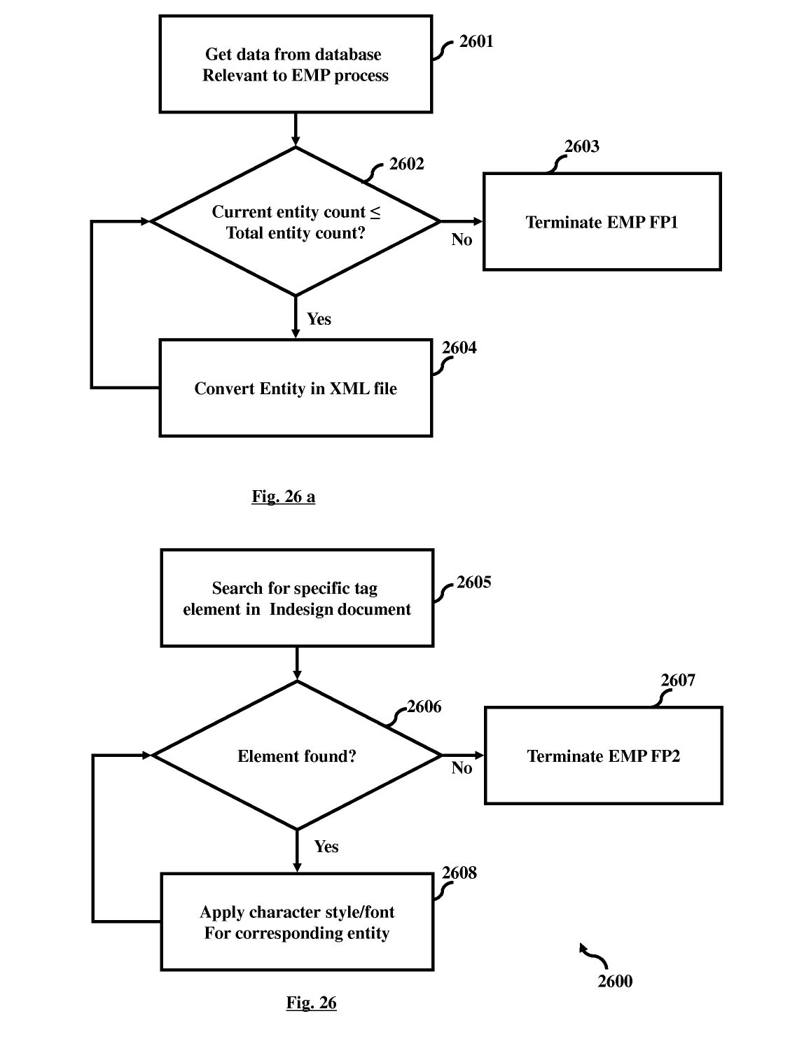

FIG. 26 is a flow diagram, which shows the forward process (FP) in Entity Mapping (EMP) as disclosed in the embodiments herein. Entity mapping is the process of replacing a given entity with another and applying font/character style. The Forward Process 1 does replacement of entity in the XML file before import and first process happens in XML file. In the Forward process 1, convert the entities in the XML file based on the entities mapped in EMP. In the Forward Process 2, Style is applied for replaced entity in InDesign.

In the forward process 1, application fetches (2601) data related to EMP process from the database. Then the application checks (2602) if current entity count is less than or equal to total entity count. If current entity count is not less than or equal to total entity count, 1^{st} Forward Process in Entity Mapping Process is terminated (2603). If current entity count is less than or equal to total entity count, entity conversion module is executed to search and replace (2604) 1^{st} entity with 2^{nd} entity in the XML file. In an embodiment, tag “dia” is assigned to the replaced document.

Forward Process 2 does application of font/character styles, which happens in Adobe InDesign document. The process happens in Adobe InDesign. In forward process 2, the application search (2605) for the entity created by forward process 1 using the tag assigned for that particular entity. If the element is not found, 2^{nd} forward process in entity mapping process is terminated (2607). If the element is found, character style and font is applied (2608) to that particular entity. The various actions in method 2600 may be performed in the order presented, in a different order or simultaneously. Further, in some embodiments, some actions listed in FIG. 26 may be omitted.

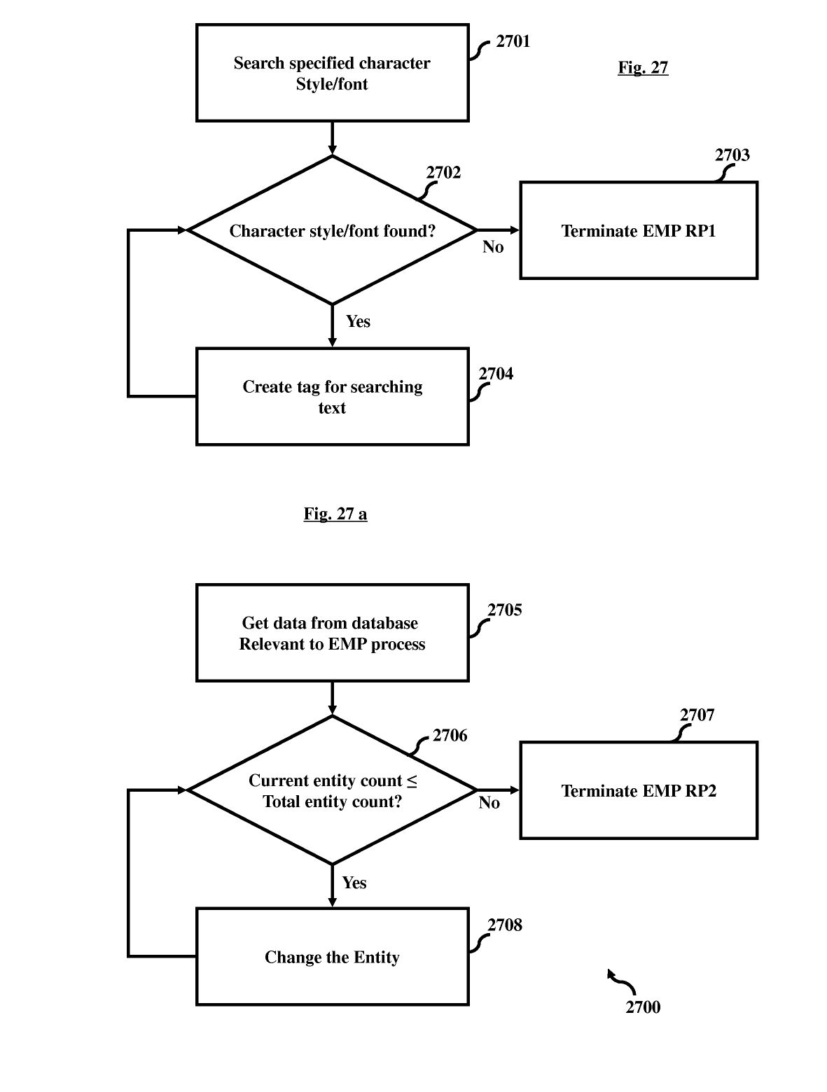

FIG. 27 is a flow diagram, which shows the reverse process (RP) in Entity Mapping (EMP) as disclosed in the embodiments herein. Entity mapping is the process of replacing a given entity with another and applying font/character style. In Reverse Process 1 (RP1), the specified character style/font in specified XPATH is searched for and the entity found is marked for identification. In the Reverse Process 2 (RP2), the marked entity is replaced by the original entity.

In Reverse Process1, the application initially search (2701) for the specified character style/font and checks (2702) after a particular time if the specified character style/font is found. If the specified character style/font is not found, the 1^{st} Reverse Process in Entity Mapping Process is terminated (2703). If the specified character style/font is found, a particular tag is assigned (2704) for that particular text. In an embodiment, the assigned tag can be used for easy identification of that particular text or element.

In Reverse Process2, the application fetches (2705) data relevant to Entity Mapping process from database and checks (2706) if the current entity count is less than or equal to the total entity count. If the current entity count is not less than or equal the total entity count, Reverse Process 2 in Entity Mapping process is terminated (2707). If current entity count is less than or equal to the total entity count, entity module is executed (2708) in XML file so as to search and replace Entity 2 with Entity 1. In an embodiment, the application process search for a particular entity using the tag assigned for that particular entity. The various actions in method 2700 may be performed in the order presented, in a different order or simultaneously. Further, in some embodiments, some actions listed in FIG. 27 may be omitted.

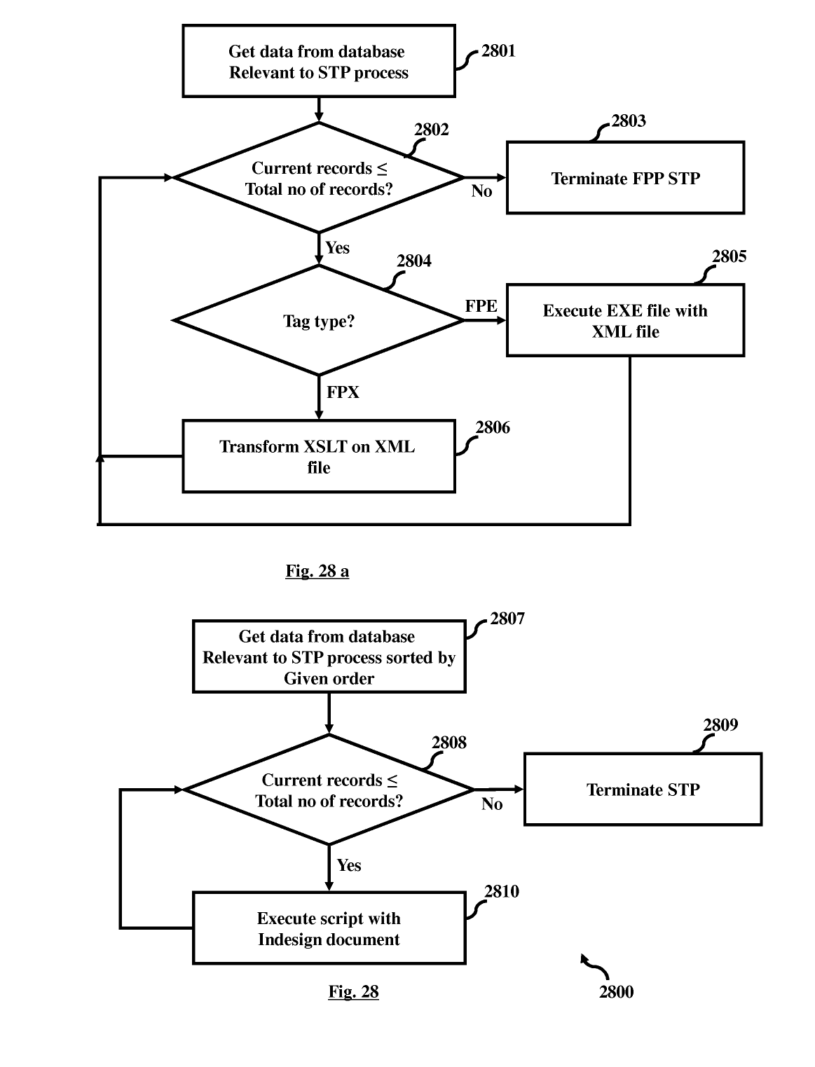

FIG. 28 is a flow diagram which shows the forward process (FP) sub tools for Pre and Post process (STP) as disclosed in the embodiments herein. Sub Tools are used to support additional process specific to client's requirements.

Forward pre process relates to processes pertaining to XML. In an embodiment, Forward Pre process is of two types. In the first type, XSLT is executed on XML file so as to get transformed XML file as output. In Type 2, executable application is executed on XML file.

Forward Post process relates to process pertaining to InDesign document. Further, user defined scripts are executed with InDesign document.

In Forward Pre Process, the application initially fetches data related to STP from the database. In an embodiment, the application fetches data with tags “FPE” and “FPX” which is sort in a given order. Then the application checks (2802) if the current record is less than or equal to total number of records. If the current record is not less than or equal to total number of records, the Forward Pre Process in STP is terminated (2803). If the current record is less than or equal to total number of records, the application check (2804) tag type of the fetched file. In an embodiment, the application checks if the tag associated with that particular file is “FPE” or “FPX”. If the tag associated with that particular file is “FPE”, the application executes (2805) “EXE” file with “XML” file. If tag type is of “FPX”, sub tool “XSLT” is transformed on “XML” file.

In Forward Post Process, the application fetches (2807) data relevant to STP process and with the tag “FFS” from the database. In an embodiment, the fetched data is sorted in an order. In another embodiment, the order in which the fetched data is sorted is decided by the user according to the application. Then the application checks (2808) if current record is less than or equal to total number of records. If current record is not less than or equal to total number of records, the Forward post process STP is terminated (2809). If current record is less than or equal to total number of records, script is executed (2810) with InDesign document. The various actions in method 2800 may be performed in the order presented, in a different order or simultaneously. Further, in some embodiments, some actions listed in FIG. 28 may be omitted.

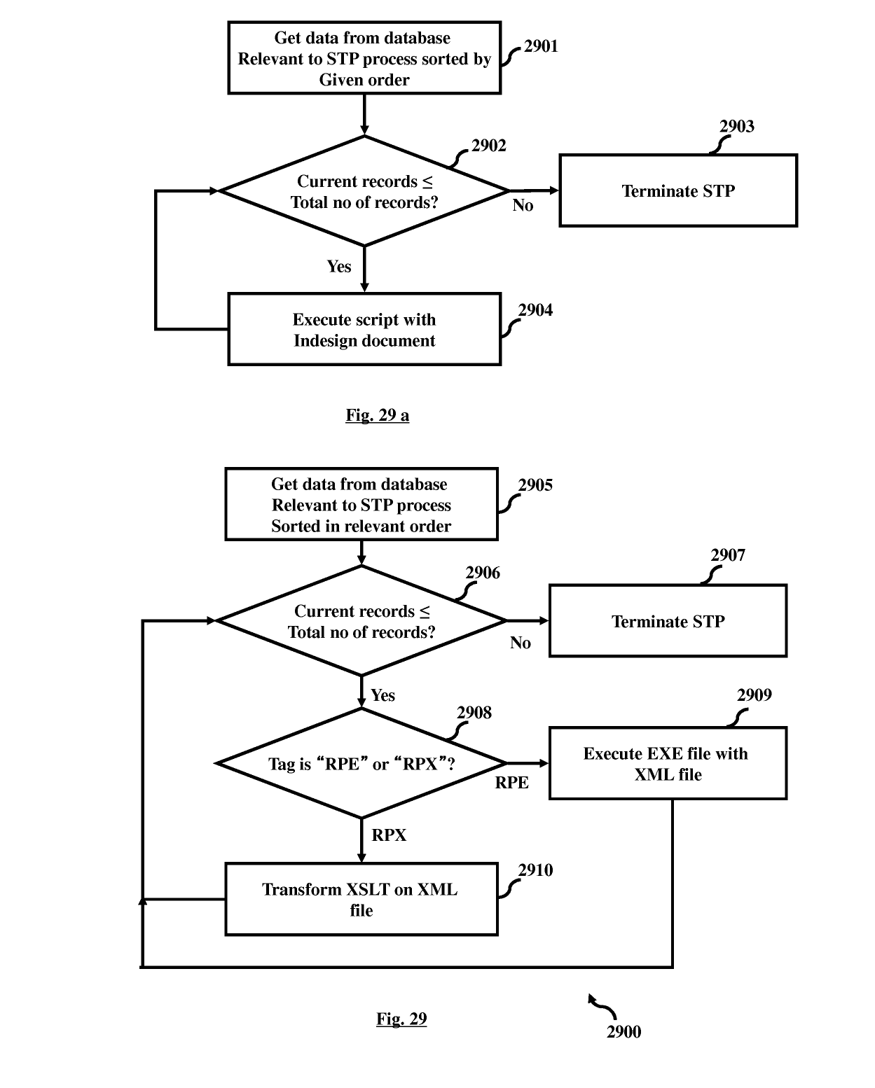

FIG. 29 is a flow diagram which shows the reverse process (RP) sub tools for Pre and Post process (STP) as disclosed in the embodiments herein. Reverse pre process refers to execution of user defined scripts with InDesign document. In Reverse Post Process, either XSLT is executed on XML file to get transformed as output or executable application is executed on XML file.

In Reverse pre process, the application fetch (2901) data related to STP and with tag “RPS” from the database. Then the application checks (2902) if current record is less than or equal to total number of records. If current record is less than or equal to total number of records, script is executed (2904) with InDesign document. If current record is not less than or equal to total number of records, STP process is terminated (2903).

In Reverse Post process, the application fetch (2905) data related to STP and with any of the tags “RFE” or “RFX”. In an embodiment, the fetched data is sorted in a given order. Then the application checks (2906) if current record is less than or equal to total number of records. If current record is not less than or equal to total number of records, STP process is terminated (2907). If current record is less than or equal to total number of records, then the application checks (2908) whether the tag associated with that particular file is “RPE” or “RPX”. If the tag associated with that particular file is “RPE”, EXE file is executed with XML file (2909). If the tag associated with that particular file is “RPX”, sub tool “XSLT” is transformed (2910) on the XML file. The various actions in method 2900 may be performed in the order presented, in a different order or simultaneously. Further, in some embodiments, some actions listed in FIG. 29 may be omitted.

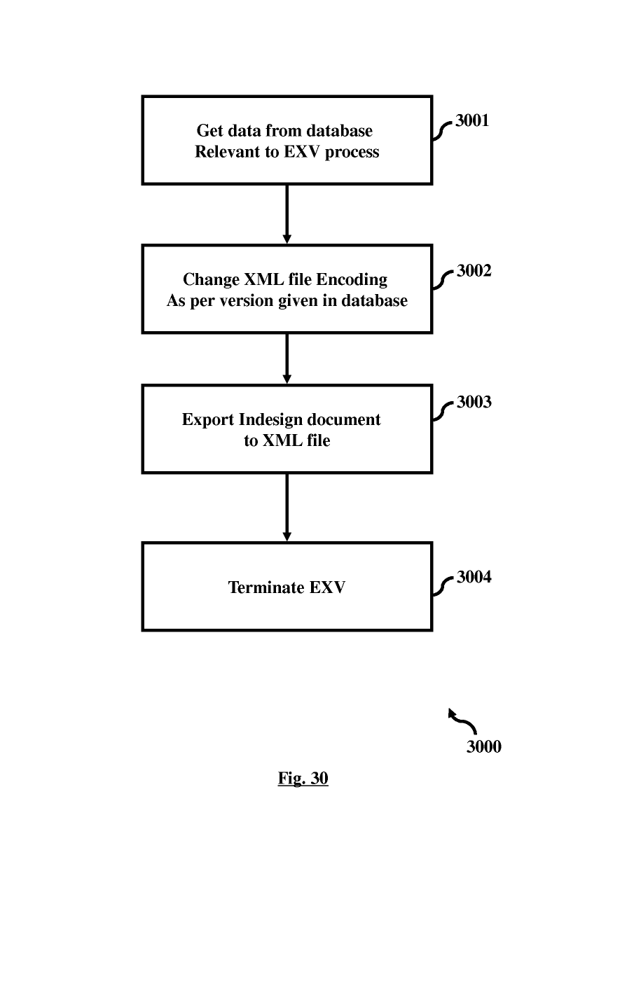

FIG. 30 is a flow diagram, which shows the process of Exporting XML Version (EXV) as disclosed in the embodiments herein. EXV is used for automating export of InDesign document in specified XML version.

The application initially fetches (3001) data related to EXV from the database. Then the application changes (3002) XML file encoding as per version given in database. Then the InDesign document is exported (3003) to “XML” file and the EXV process is terminated (3004). The various actions in method 3000 may be performed in the order presented, in a different order or simultaneously. Further, in some embodiments, some actions listed in FIG. 30 may be omitted.

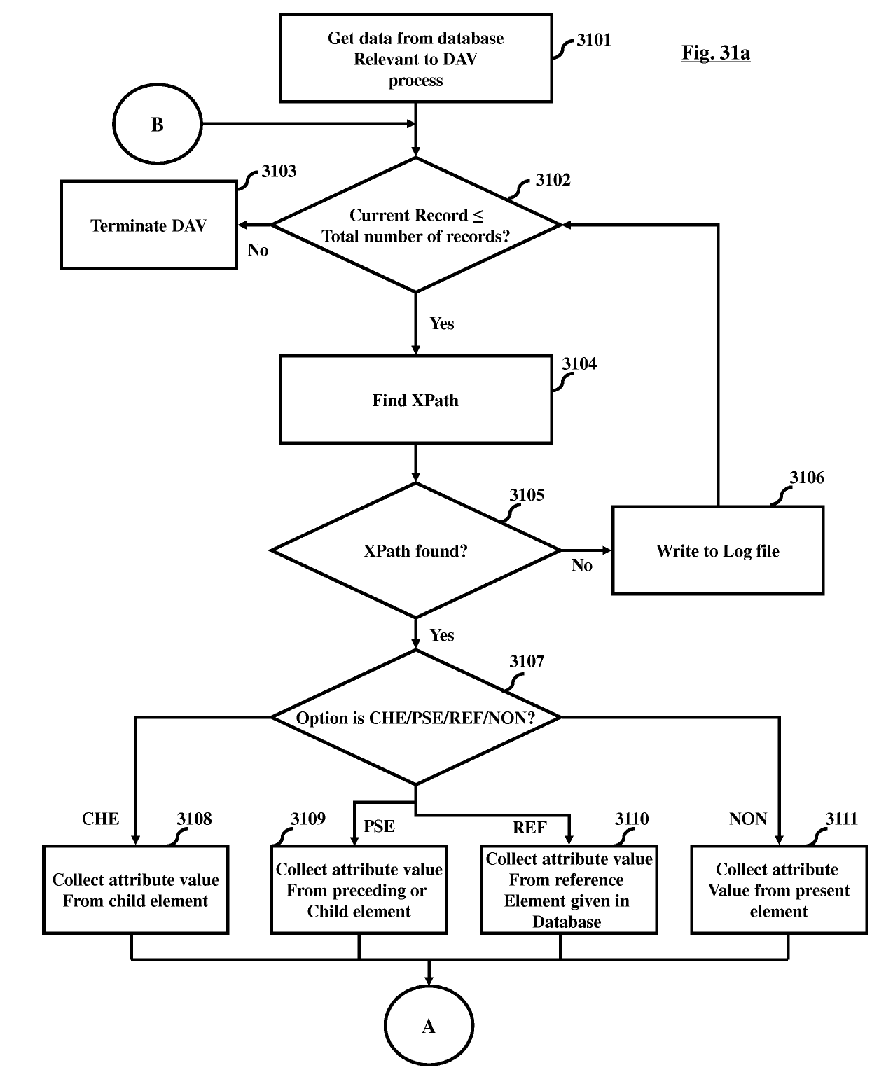

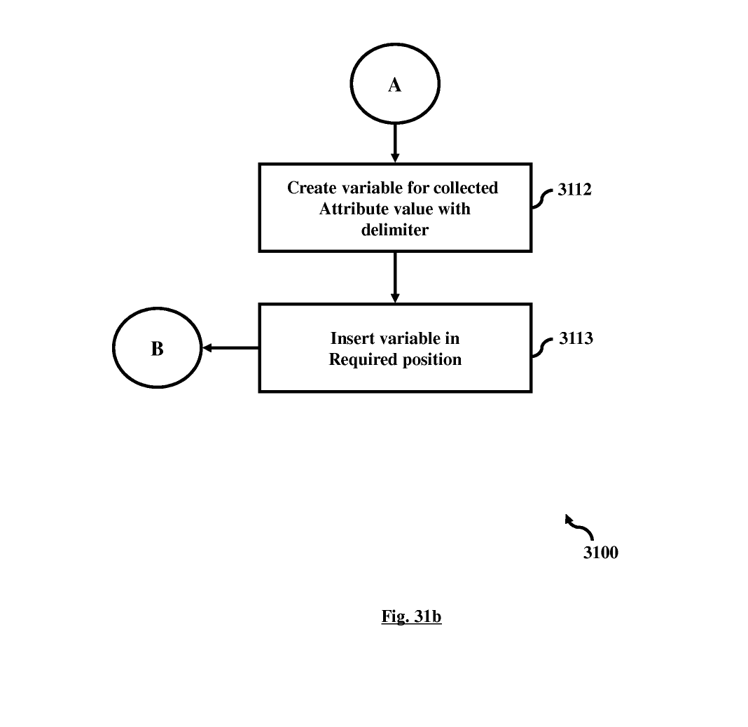

FIGS. 31a-31b are flow diagrams, which show the process of Displaying Attribute Value in document for cross-reference as disclosed in the embodiments herein. Attributes provides additional information about an XML document. Further, each attribute consist of a name and a value. The process DAV automates display of XML attributes value in a document.

The application initially fetches (3101) data from database. In an embodiment, the application fetches data of a specific type. In another embodiment, the data is of type “PXE”. Then the application checks (3102) if the current record is less than or equal to total number of records. If the current record is not less than or equal to total number of records, then the process is terminated (3103). If the current record is less than the total number of records, then the application tries to find out (3104) XPath and checks (3105) after a particular time period, if the XPath exists or not. If XPath does not exist, then corresponding entry is made (3106) in Log file and proceed with the next record (3102). If XPath is found, the application checks (3107) from which element, the attribute value is to be collected. In an embodiment, the user is given an option to decide from which element attribute is to be retrieved. In another embodiment, the user is provided with certain options so as to select the element from which attribute is to be collected. In another embodiment, the options provided to user may be denoted as “CHE”, “PSE”, “REF” and “NON”. However, the notations used are for the purpose of giving an example and does not limit the scope of invention.

If the option is “CHE”, the application collects (3108) attribute value from child element. If the option selected is “PSE”, the application collects (3109) attribute value from preceding or child elements. If the option selected is “REF”, the application collects (3110) attribute values from reference element given in database. If the option selected is “NON”, the application collects (3111) attribute values from present element. After collecting attribute values, the application creates (3112) for the collected attribute value with delimiter. Then the application insert (3113) variable in required position of the document. The various actions in method 3100 may be performed in the order presented, in a different order or simultaneously. Further, in some embodiments, some actions listed in FIGS. 31a-31b may be omitted.

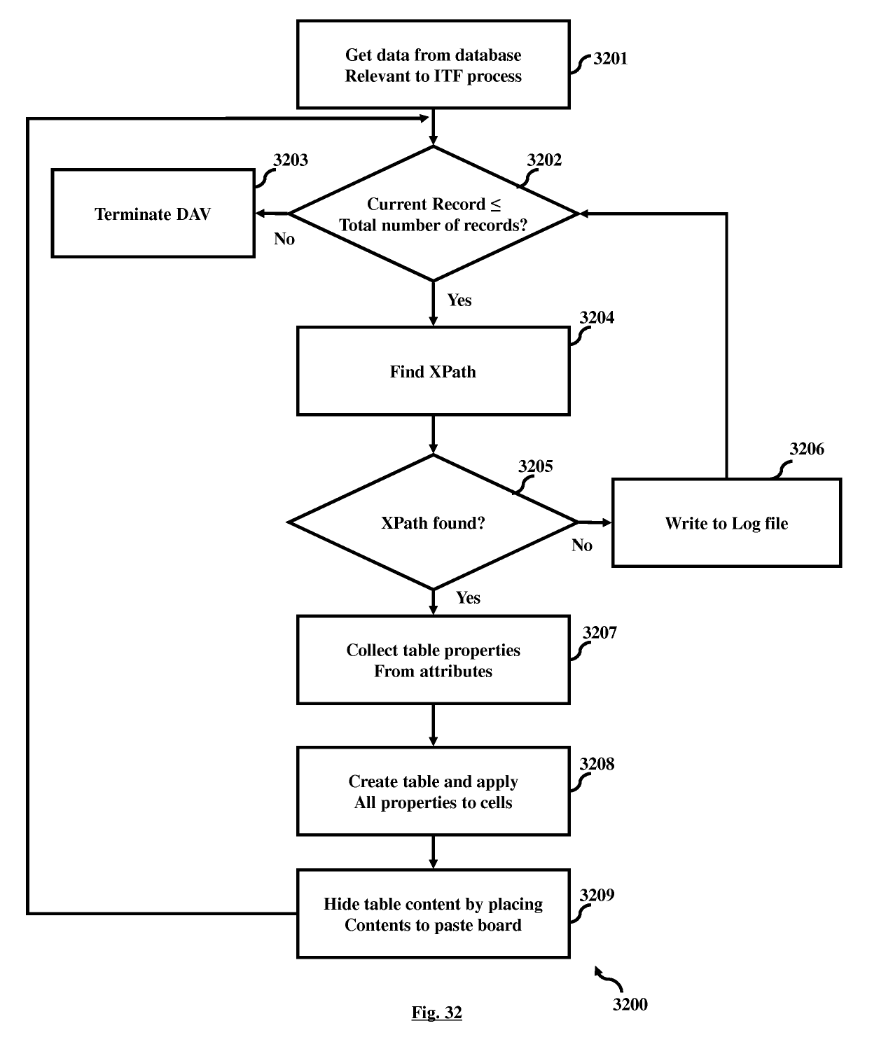

FIG. 32 is a flow diagram which shows the process of InDesign table Formatting (ITF) as disclosed in the embodiments herein. Tables are formatted using table and cell styles. Further, a table style is a collection of table formatting attributes. In an embodiment, table-formatting attributes may comprise table borders and row and column strokes that can be applied in a single step. In another embodiment, a cell style comprises formatting cell insects, paragraph styles and strokes and fills. Further, properties collected from attributes are applied to relevant cells of table.

The application initially fetches (3201) data from database. In an embodiment, the application fetches data of a specific type. In another embodiment, the data is of type “ITF”. Then the application checks (3202) if the current record is less than or equal to total number of records. If the current record is not less than or equal to total number of records, then the process is terminated (3203). If the current record is less than the total number of records, then the application tries to find out (3204) XPath and checks (3205) after a particular time period, if the XPath exists or not. If XPath does not exist, then corresponding entry is made (3106) in Log file and proceed with the next record (3202). If XPath is found, the application collects (3207) table properties from attributes. Then a table is created and the collected table properties are applied (3208) to all the cells of the newly created table. Then the table contents are hidden (3209) by placing the table contents to a pasteboard. Then the application continues the process of finding XPath. The various actions in method 3200 may be performed in the order presented, in a different order or simultaneously. Further, in some embodiments, some actions listed in FIG. 32 may be omitted.

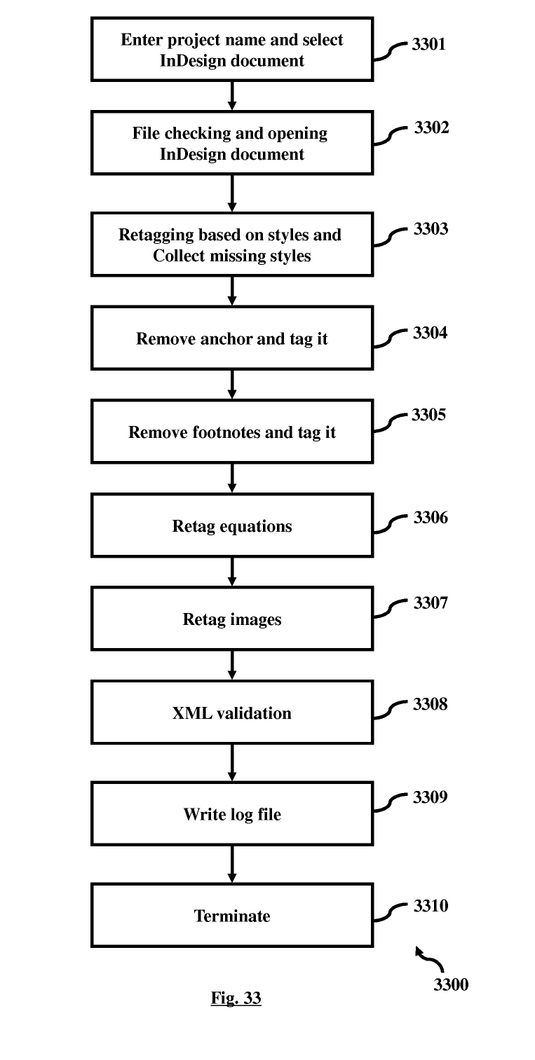

FIG. 33 is a flow diagram which shows the process of Retagging in InDesign document as disclosed in the embodiments herein. All elements are enclosed within tags in an XML file. Retagging functionality in InXML allows retagging of InDesign document.

Initially, the user enters project name and selects (3301) the InDesign document to be retagged from the application folder. Then the application performs (3302) file checking and opens the selected InDesign document. Then the application retags (3303) the document based on styles and also collect missing styles. Then the application removes anchor from the selected document and tag (3304) the anchors. Then the footnotes are removed (3304) from the document and are tagged (3305). Then all the equations present in the documents are retagged (3306) after which the images present in the document are tagged (3307). Then the application performs XML validation (3308) of the tagged document and corresponding entries are made (3309) in a Log file. Then the retagging process is terminated (3310). The various actions in method 3300 may be performed in the order presented, in a different order or simultaneously. Further, in some embodiments, some actions listed in FIG. 33 may be omitted.

The embodiments disclosed herein can be implemented through at least one software program running on at least one hardware device and performing network management functions to control the network elements. The network elements shown in FIG. 2 include blocks, which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for automatic pagination of an INDESIGN document using an input XML document on a computerized system, said method comprising:
presenting a list of available pagination processes by said system;
providing input including selecting one or more pagination processes from said list of available pagination processes by a user;
storing selected pagination processes, said input document, and inputs related to said selected processes in a database on said system;
processing said input document using the stored pagination processes and said related inputs, when a pagination request is invoked; and
generating a paginated output document after applying the pagination processes.

2. The method as in claim 1, wherein information stored in said database includes at least one of Document Type Declarations (DTD), XML, images, InDesign templates, supporting files and libraries.

3. The method as in claim 1, wherein said database is created by employing a DBInXML tool.

4. The method as in claim 1, wherein said processing of XML input document comprises:
executing commands specified in the selected pagination process; and
applying appropriate commands on said input document by employing instructions based on inputs stored in said database.

5. The method as in claim 4, wherein said method comprises interacting with third party plug-in such as MatchMagic, InMath, PowerMath, MathType and Calibre during said processing.

6. The method as in claim 1, where said pagination processes include commands for at least one of InDesign format attribute conversion (IFA), Placing XML elements (PXE), Insertion of Paragraph Mark (IPM), Hiding Unwanted XML Contents (HUX), Extended Pages (EP), Applying Styles (AS), Equation Conversion Process (ECP), Preceding Sibling Checking (PSC), Inside Placement (IP), Outside Placement (OP), Foot Notes, Applying Master Page (AMP), Different Layers (DLE), Slug Frames (SLG), Attribute Deletion (ADL), Insertion of XML content or variable (ICV), Sub tools for pre and post process (STP), Export XML version (EXV), Display Attributes Value (DAV) and InDesign Table Formatting (ITF) processes as per said user's requirements.

7. A computerized system for automation pagination of an INDESIGN document using an input XML document, said system comprising:
a source of pagination processes to select from;
a database to store said input document, selected pagination processes,
and inputs related to said selected pagination processes; and
a processor for processing said input document and generating an paginated output document using said selected pagination processes and said related inputs, when a pagination request is invoked.

8. The system of claim 7, wherein said pagination processes selected include at least one of InDesign format attribute conversion (IFA), Placing XML elements (PXE), Insertion of Paragraph Mark (IPM), Hiding Unwanted XML Contents (HUX), Extended Pages (EP), Applying Styles (AS), Equation Conversion Process (ECP), Preceding Sibling Checking (PSC), Inside Placement (IP), Outside Placement (OP), Foot Notes, Applying Master Page (AMP), Different Layers (DLE), Slug Frames (SLG), Attribute Deletion (ADL), Insertion of XML content or variable (ICV), Sub tools for pre and post process (STP), Export XML version (EXV), Display Attributes Value (DAV) and InDesign Table Formatting (ITF) as per said user's requirements.

9. A computerized method for conversion of an input INDESIGN document into a specified format by converting said input document into XML format, said method comprising:
removing variables inserted during content variable process and attributes selected;
reversing table formatting processes;
obtaining XPath information from a database;
searching for specified style/font using XPath and marking entries found; and
exporting an XML output file from said input document.

10. The method as in claim 9, said method comprising converting said exported XML file into said specified format, wherein said specified format is not XML, said conversion comprising:
replacing said entries found with original entity found using sub tools in the XML document; and
converting XML document to said specified format.

11. The method as in claim 10, wherein said specified format is one among NIMAX XML, ePUB, and MICROSOFT WORD.

12. The method as in claim 11, wherein said conversion of XML output into word document is done with or without frames.

13. The method as in claim 11, wherein said conversion of XML output into ePUB format further comprises:
converting XML output into HTML; and
converting the HTML format into ePUB document.
